(19) United States
(12) Patent Application Publication
(10) Pub. No.: US 2014/0050084 A1
(43) Pub. Date: Feb. 20, 2014

(54) METHOD OF GROUP BASED MACHINE TYPE COMMUNICATION AND APPARATUSES USING THE SAME

(71) Applicant: INDUSTRIAL TECHNOLOGY RESEARCH INSTITUTE, Hsinchu (TW)

(72) Inventor: Ching-Wen Cheng, Tainan City (TW)

(73) Assignee: INDUSTRIAL TECHNOLOGY RESEARCH INSTITUTE, Hsinchu (TW)

(21) Appl. No.: 13/729,031

(22) Filed: Dec. 28, 2012

Related U.S. Application Data
(60) Provisional application No. 61/691,255, filed on Aug. 20, 2012.

(51) Int. Cl. H04W 28/02

(52) U.S. Cl. CPC H04W 28/0215
USPC 370/230; 370/312

(57) ABSTRACT

A method of group based machine type communications (MTC) and apparatuses using the same are proposed to minimize unexpected network response by the way of group based MTC function translations and adjustments. According to the method and the apparatus performing the method, grouping and re-grouping in both in the network level and the application server level could be performed to minimize functional discrepancies among required functions for a MTC service, functions supported by a network, and functions available for MTC UEs. Functional discrepancies after the initial grouping may be solved by performing functional adjustment and translation. By using this group based method and apparatuses, not only control signal overheads are saved but the likelihood of network congestion or overload due to error signals could be lowered.

### CROSS REFERENCE TO RELATED APPLICATION

This application claims the priority benefit of U.S. provisional application Ser. No. 61/691,255, filed on Aug. 20, 2012. The entirety of the above-mentioned patent application is hereby incorporated by reference herein and made a part of this specification.

### BACKGROUND

1. Technical Field

The present disclosure generally relates to a method of group based machine type communications (MTC) and apparatuses using the same. More specifically, the present disclosure provides a method of group based machine type communications to minimize unexpected network response by the way of group based MTC function translations and adjustments.

2. Related Art

Machine type communication (MTC) is a form of data communication which involves one or more entities that do not necessarily need human interaction. A MTC device could be a user equipment equipped for MTC or a device deployed with MTC applications, which may communicate through a Public Land Mobile Network (PLMN) (e.g. the mobile network of a service provider) with MTC Server(s)/MTC application server(s) and/or other MTC device(s). A MTC device may also communicate locally (wirelessly, through a PAN, or hardwired) with other entities which provide the MTC device “raw data” for processing and communicating with MTC Server/MTC application server(s) (AS) and/or other MTC device(s).

Examples of MTC devices could belong to but not limited to these following categories: I. UEs (e.g. mobile handsets) equipped with MTC applications or functions. II. vehicular devices, e.g. speedometer, odometer, anti-theft devices, road side monitors, and etc. III. personal health care devices including blood pressure sensor, blood sugar sensor, pace maker, and etc. IV. (stationary) homeland safety monitors which may include earthquake detectors, landslide detectors, and bridge monitors such as the 1500 plus sensors & monitors on Golden Gate Bridge in San Francisco, etc. V. Smart meters such as utility meters, parking meters, and etc.

MTC devices may belong to a MTC Group, and a MTC group may be defined as a group of MTC Devices that share one or more MTC Features and that may belong to the same MTC Subscriber. A MTC group may share common MTC features or functions which may be referred to as network features or functions used to optimize the network for use by MTC applications. A MTC network may have at least one MTC Server which provides services to MTC users and MTC Devices through at least a network. The MTC Server may also have an interface which may be accessed by the MTC user which in turn uses the service provided by the MTC Server. A MTC user however may need to first subscribe to a MTC server and/or a network. A MTC Subscriber is a legal entity having a contractual relationship with the network operator to provide service to one or more MTC Devices. (Typically a MTC service provider is the party holding subscriptions in order to provide connectivity between MTC Devices and the MTC Server. In practice certain roles can collapse, e.g. the network operator acts at the same time as MTC Service Provider.)

Machine Type Communications (MTC) or Machine to Machine (M2M) Communications is a development of the communication industry. The quantities of MTC devices is expected to far exceeds quantities of typical handheld mobile devices, the large volumes of communication traffic transmitted for MTC services including MTC data and control signals could impose a serious burden on any communication networks if left uncontrolled. In order to streamline MTC communications by reducing the volume of control and data traffic as well as to enhance MTC manageability, resorting to group based MTC control is an efficient and unavoidable trend in the communication industry.

The group based MTC communications would effectively reduce the amount of traffic while a MTC application server or a MTC communication network communicates or interacts with large quantities of MTC apparatus. Group-based control and data traffic could be configured to control a set of multiple MTC devices at a time or to exchange information and data between a set of multiple MTC devices and a MTC application server and/or a MTC network at a time. ESTI and 3GPP are two of the largest communication standard organizations from which specific requirements for group-based MTC communications have been formulated as each member of a MTC group must abide by their standardized settings or specifications.

Hence, for group-based MTC communications, if a Mobile Operator Network (MON) is unable to supply one or more of the MTC functions or features as required by a MTC server/MTC application server (AS), or if some MTC user equipments (UE) within a MTC group are not able to support certain required MTC functions or features, then these MTC devices either as a group or individually could transmit error signals or re-transmit requests to their respective application servers and/or MTC network. The quantity of error signals or re-transmission requests could be enormous as the number of active MTC UEs could be very large, and thus the MON would be congested or overloaded accordingly.

For the purpose of circumventing the situation in which the MTC functions or features required by an AS exceed beyond the capabilities of corresponding MONs or MTC UEs, and thus inducing unnecessary re-transmissions or error signals, measures could be from the MTC server/MTC application servers (AS), the MTC service capability platform (SCP), or MTC Mobile Operator Networks (MON) in order to prevent or to minimize error signals or re-transmission requests. For instance, there must be a way to address the grouping and/or the re-grouping of MTC devices as well as a way to adjust or to translate the functions and/or features requested by the MON and/or SCP and/or the AS.

### SUMMARY OF THE DISCLOSURE

The present disclosure addresses the aforementioned shortcoming by proposing a method, a machine type communication (MTC) application server (AS) using the same method, and a third party or operator controlled MTC service capability platform (SCP) using the same method.

Accordingly, the present disclosure proposes a method of machine type communications (MTC) for use by a service provider to provide a first group based MTC service having a plurality of MTC functions to MTC subscribers, and the method includes the steps of (a) grouping subscribers dynamically according to the serving network of the subscribers so that each group has one serving network, (b) detecting for each group whether the serving network of the group supports all of the plurality of MTC functions of the MTC service, when the serving network of the group does not support all of the plurality of the MTC functions of the first group based MTC service, (c) adjusting the plurality of MTC functions of the first group based MTC service to produce a second group based MTC service, and (d) delivering the second group based MTC service to the group.

Accordingly, the present disclosure proposes a method of machine type communications (MTC) for use by a network to transmit a first group based MTC service having a plurality of MTC functions to MTC subscribers, and the method includes the steps of grouping subscribers under the network dynamically according to reachability information of the subscribers, detecting for each group whether the network can perform all of the plurality of MTC functions of the first group based MTC service transmitted by the network, when the network cannot perform all of the plurality of the MTC functions of the first group based MTC service, adjusting the plurality of MTC functions of the first group based MTC service to produce a second group based MTC service if the plurality of MTC functions of the first group based MTC service are adjustable, and delivering the second group based MTC service to the group.

The present disclosure directs to a machine type communication (MTC) application server comprising a processing circuit and a transceiver connected to the processing circuit, wherein the processing circuit is configured for performing these following functions through the transceiver including (a) grouping subscribers dynamically according to the serving network of the subscribers so that each group has one serving network, (b) detecting for each group whether the serving network of the group supports all of the plurality of MTC functions of the MTC service, when the serving network of the group is not capable of supporting all of the plurality of the MTC functions of the first group based MTC service, (c) adjusting the plurality of MTC functions of the first group based MTC service to produce a second group based MTC service, and (d) delivering the second group based MTC service to the group.

The present disclosure directs to a machine type communication (MTC) service capability server comprising a processing circuit and a transceiver connected to the processing circuit, wherein the processing circuit is configured for performing these following functions through the transceiver including (a) grouping subscribers dynamically according to the reachable network of the subscribers so that each group has one serving network, (b) detecting for each group whether the serving network of the group supports all of the plurality of MTC functions of the MTC service, when the serving network of the group is not capable of all of the plurality of the MTC functions of the first group based MTC service, (c) adjusting the plurality of MTC functions of the first group based MTC service to produce a second group based MTC service, and (d) delivering the second group based MTC service to the group.

The present disclosure directs to a network for A machine type communication (MTC) configured for performing these following functions through the transceiver including grouping subscribers under the network dynamically according to reachability information of the subscribers, detecting for each group whether the group can perform all of the plurality of MTC functions of the first group based MTC service transmitted by the network, when the group cannot perform all of the plurality of the MTC functions of the first group based MTC service, adjusting the plurality of MTC functions of the first group based MTC service to produce a second group based MTC service if the plurality of MTC functions of the first group based MTC service are adjustable, and delivering the second group based MTC service to the group.

In order to make the aforementioned features and advantages of the present invention comprehensible, preferred embodiments accompanied with figures are described in detail below. It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A illustrates various MTC deployment scenarios in accordance with the present disclosure.

FIG. 1B illustrates an example of a MTC network architecture in accordance with the present disclosure.

FIG. 1C illustrates one of the concepts of group based MTC network architecture in accordance with the present disclosure.

FIG. 1D illustrates one of the concepts of group based MTC network architecture in accordance with the present disclosure.

FIG. 1E illustrates one of the examples of group based MTC network architecture in accordance with the present disclosure.

FIG. 1F illustrates one of the examples of group based MTC functional adjustment and translation in accordance with the present disclosure.

FIG. 1G illustrates one of the examples of group based MTC functional adjustment and translation in accordance with the present disclosure.

FIG. 1H illustrates one of the examples of group based MTC functional adjustment and translation in accordance with the present disclosure.

FIG. 1I illustrates an overall process flow chart in accordance with the present disclosure.

FIG. 2 illustrates group based MTC without mobility in accordance with one of the exemplary embodiments of the present disclosure.

FIG. 3 illustrates MTC network reference data in accordance with the present disclosure.

FIG. 4 illustrates group based MTC with mobility in accordance with one of the exemplary embodiments of the present disclosure.

FIG. 5A illustrates a first scenario of group based MTC with mobility in accordance with one of the exemplary embodiments of the present disclosure.

FIG. 5B illustrates a second scenario of group based MTC with mobility in accordance with one of the exemplary embodiments of the present disclosure.

FIG. 5C illustrates a third scenario of group based MTC with mobility in accordance with one of the exemplary embodiments of the present disclosure.

FIG. 5D illustrates a fourth scenario of group based MTC with mobility in accordance with one of the exemplary embodiments of the present disclosure.

FIG. 6A is a block diagram illustrating group based MTC functions translation and adjustment from the perspective of a service provider in accordance with one of the exemplary embodiments of the present disclosure.

FIG. 6B is a block diagram illustrating group based MTC functions translation and adjustment from the perspective of a service provider in accordance with another exemplary embodiments of the present disclosure.

FIG. 7A is a block diagram illustrating group based MTC functions translation and adjustment from the perspective of a network in accordance with one of the exemplary embodiments of the present disclosure.

FIG. 7B is a block diagram illustrating group based MTC functions translation and adjustment from the perspective of a network in accordance with another exemplary embodiments of the present disclosure.

FIG. 8 illustrates a process flow procedure during a MTC service request from the perspective of an application server in accordance with one of the exemplary embodiments of the present disclosure.

FIG. 9A illustrates a process flow procedure during a MTC service request from the perspective of a network in accordance with one of the exemplary embodiments of the present disclosure.

FIG. 9B illustrates another process flow procedure during a MTC service request from the perspective of a network in accordance with one of the exemplary embodiments of the present disclosure.

FIG. 10 illustrates a device architecture of an application server (AS) or a service capability server (SCS) in accordance with one of the exemplary embodiments of the present disclosure.

FIG. 11 illustrates the processing circuit of an application server (AS) or a service capability server (SCS) in accordance with one of the exemplary embodiments of the present disclosure.

### DETAILED DESCRIPTION OF DISCLOSED EMBODIMENTS

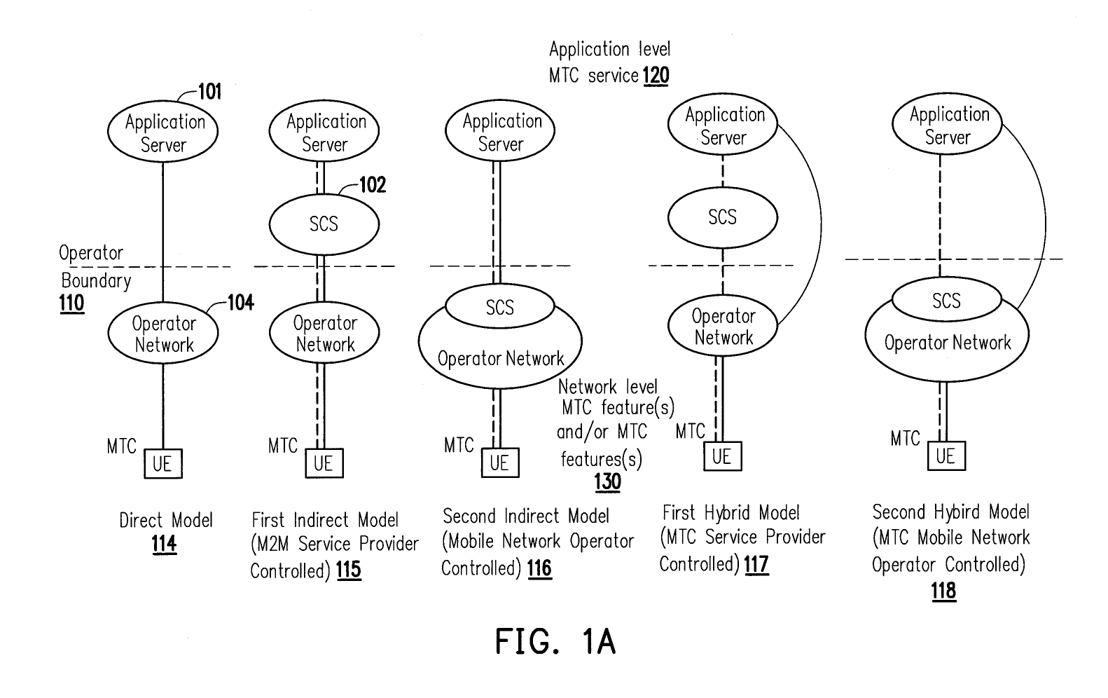

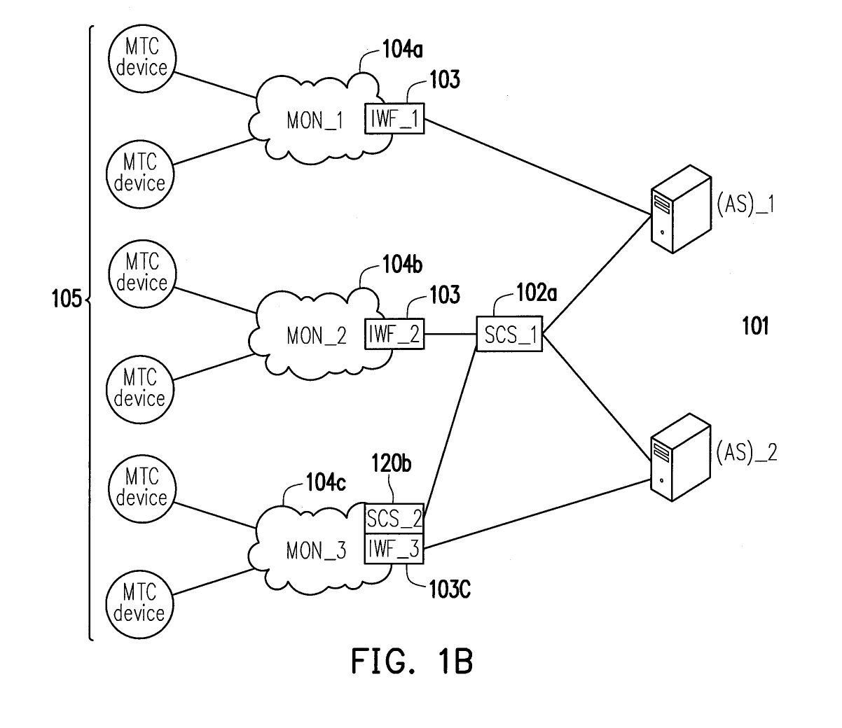

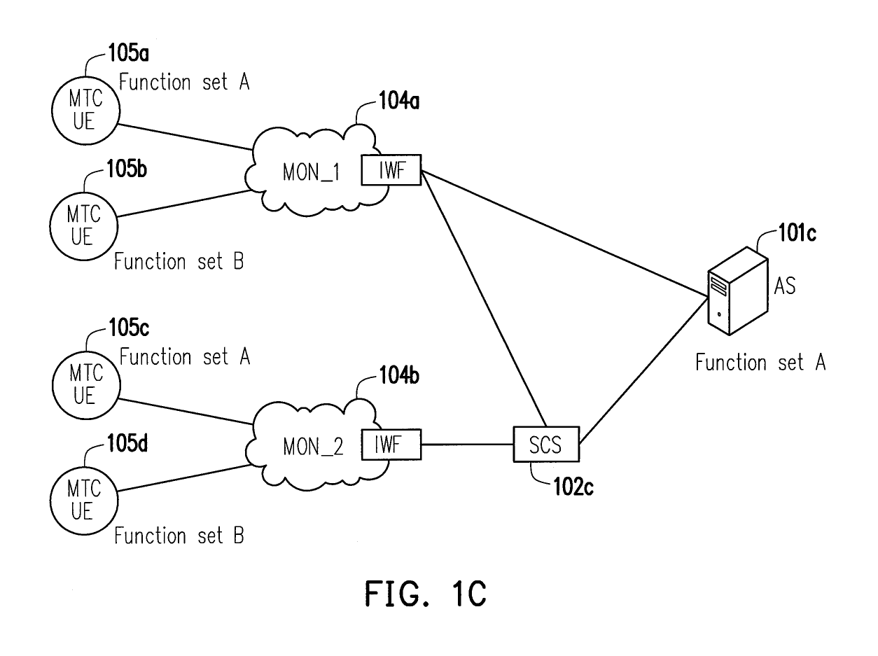

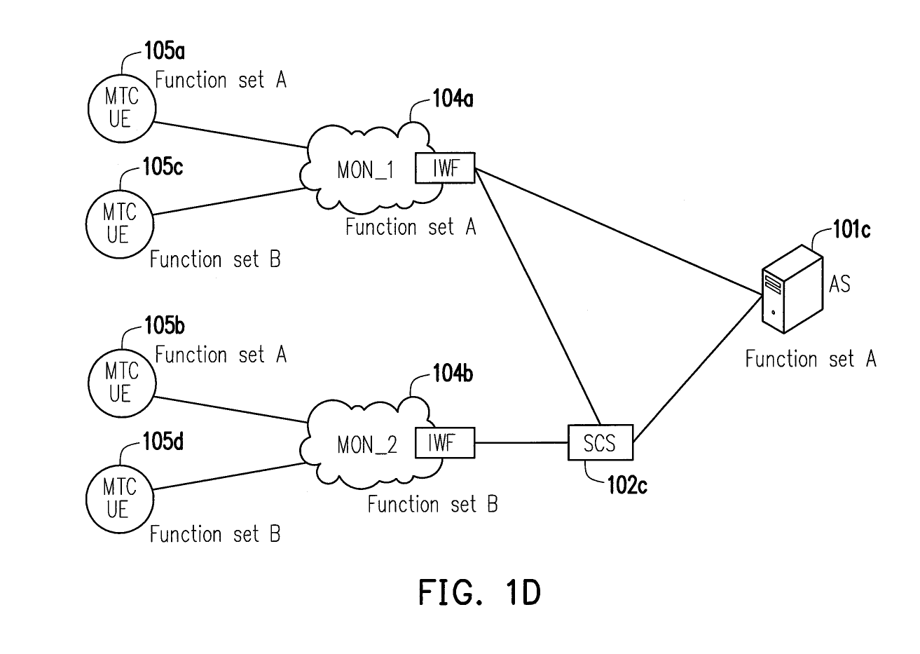

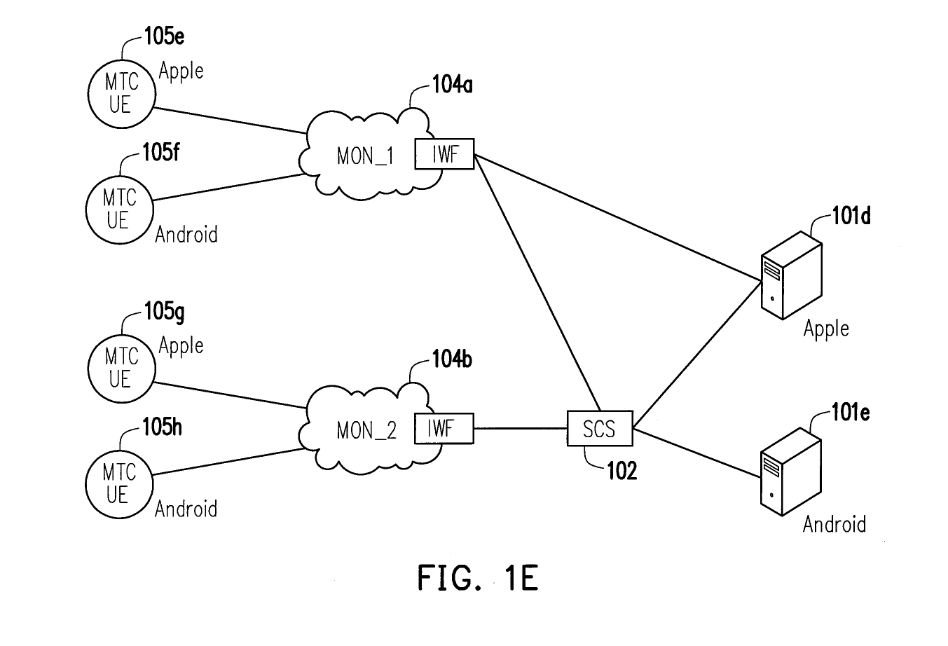

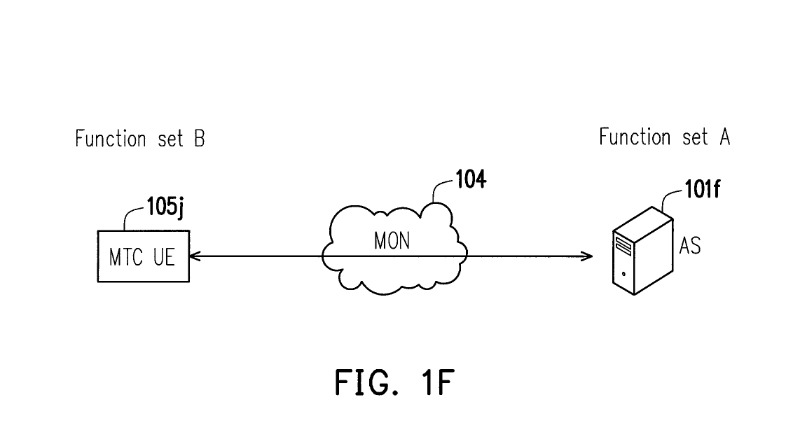

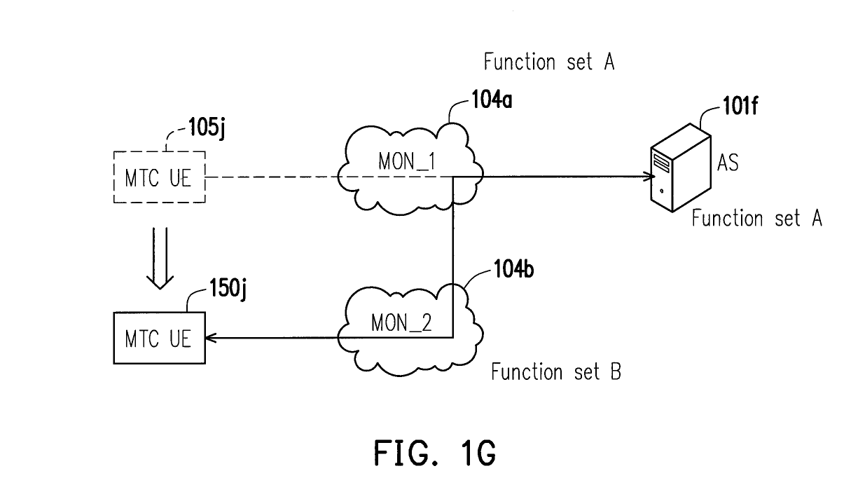

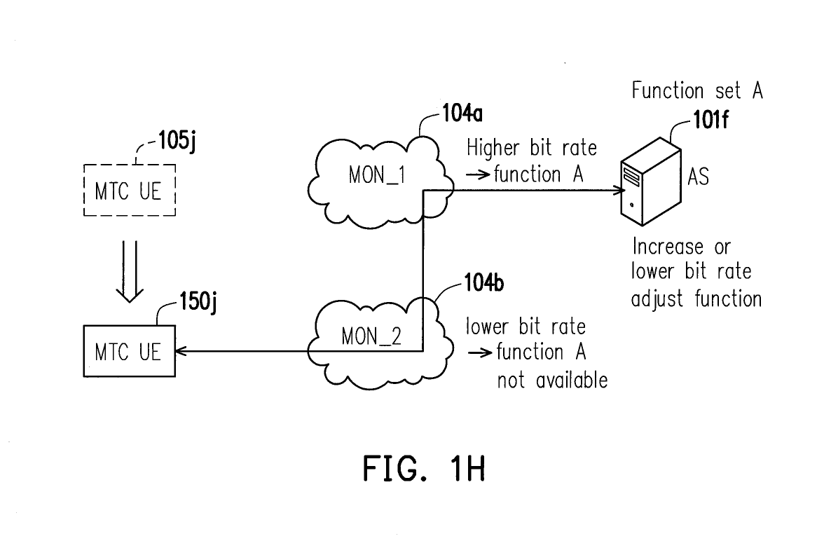

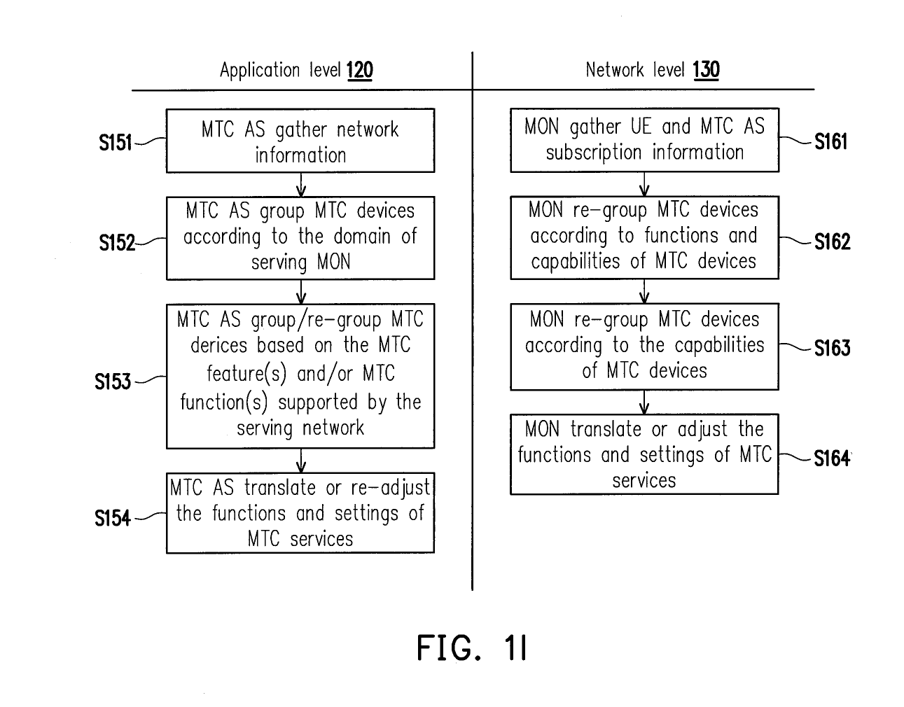

In this disclosure, 3GPP-like keywords or phrases are used merely as examples to present inventive concepts in accordance with the present disclosure; however, the same concept presented in the disclosure can be applied to any other systems such as IEEE 802.11, IEEE 802.16, WiMAX, and so like by persons of ordinarily skilled in the art. First, the design philosophy from which the present disclosure is premised upon will be described and illustrated by FIGS. 1A-1I.

FIG. 1A illustrates various MTC deployment scenarios. For the sake of easier understanding, the present disclosure uses the operator boundary 110 to demarcate the MTC communication into an application level 120 and a network level 130. The application level 120 could represent the application layer which may include at least but not limited to one or more application servers 101 (AS) and one or more service capability servers 102 (SCS). The network level 130 could represent the network layer which may include one ore more Mobile Operator Networks 104 (MON), one ore more service capability servers 102 (SCS), and one or more user equipments 105 (UEs) functioning as individual units or as groups.

In the application level 120, an application server 101 (AS) is usually under the domain of an internet service provider (ISP) or under the service domain of a mobile network operator and provides MTC services for MTC user equipments 105 (UEs). The AS 101 currently can provide an extremely wide range of MTC services without human intervention for a variety of MTC terminals 105. For instance, the AS 101 could represent a Yahoo server, a Google server, a smart meters administration server, an eHealthCare server, a traffic tracking and management server, a social networking server, and etc. An AS 101 for this disclosure represents one or more specific MTC services, each MTC service associates with a specific set of required functions.

The term “user equipment” (UE) or “MTC UE” or “MTC device” in this disclosure represents embodiments that may be, for example, a mobile station, an advanced mobile station (AMS), a server, a client, a desktop computer, a laptop computer, a network computer, a workstation, a personal digital assistant (PDA), a tablet personal computer (PC), a scanner, a telephone device, a pager, a camera, a television, a hand-held video game device, a musical device, a wireless sensor, and so like. In some applications, a UE may be a fixed computer device operating in a mobile environment, such as a bus, train, an airplane, a boat, a car, and so like. A UE or MTC UE or MTC device could be referred to any of the aforementioned embodiments which does not necessarily need human interactions.

Between the AS 101 and the UE 105, there could be a mobile operator network 104 (MON) to connect them in between. The term “mobile operator network” (MON) in this disclosure is a logical construct points to specific functions rather than specific network elements. A MON may contain at least but not limited to one or more Core Networks (CN) interfacing with one ore more Radio Access Networks (RAN) and one or more packet data networks (PDN). A Core Network (CN) may include at least one or more of these following of elements such as a Mobility Management Entity (MME), a Serving Gateway (S-GW), a Packet Data Network Gateway (PDN-GW), a Serving GPRS Support Node (SGSN), a Gateway GPRS Support Node (GGSN), a Mobile Switching Center (MSC), and a Home Subscriber Server (HSS) or a node maintaining a database related to subscriber information. A Radio Access Network (RAN) may include at least but not limited to one or more radio access nodes such as eNodeB (eNB), NodeB (NB), Base Transceiver Station (BTS), and may include one or more Radio Network Controllers (RNC), and one or more Base Station Controller (BSC). In essence, a MON performs network level communications and delivers MTC services from service providers to users.

A MON is normally operated and belonged to the domain of mobile operator companies such as Verizon, Sprint, AT&T, and etc. Since MTC service providers and mobile operator companies are two different entities, a MTC user who subscribes to a MTC service to obtain MTC services may also need to subscribe to a mobile operator network to obtain mobile network access authority of the network. A service provider may also need to subscribe to a mobile operator network in order to obtain accesses to the network as well as to obtain network transmission capabilities for providing MTC services to MTC service subscribers via the mobile operator network. The subscription not only include authorities to use a network but also may include the permission to make use of MTC features and specific functions, as well as the configuration of the subscribed MTC features and/or specific functions (e.g. various functional parameters, and one or more levels of maximum network capacities).

An AS 101 may connect to a MON 104 directly under the Direct Model 114, or an AS 101 may connect to a MON 104 indirectly through a service capability server 102 (SCS) under an Indirect Model. A SCS 102 may belong to a third party operator and may require a separate subscription, or it may operate under the domain of an ISP or a mobile operator company. For the first Indirect Model 115, a SCS 102 operates under the application level 120. In the Indirect Model 115 the control and data traffic between an AS 101 and a MON 104 may all traverse through SCS 102. For the second Indirect Model 116, a SCS 102 operates under the network level 130 or may collapse into and become a part of a MON 104 entirely. In the Indirect Model 116 the control and data traffic between and AS 101 and a MON 104 may all traverse through SCS 102. Otherwise, the MTC could operate under Hybrid Models that the control traffic and data traffic may traverse through different routes, where the control traffic may be indirect between an AS 101 and a MON 104 by traversing through one or more SCS 102 while the data traffic may be directly transmitted between an AS 101 and a MON 104. For the first Hybrid Model 117 in which the an AS 101, a SCS 102, and a MON 104 is operated and/or controlled by different service providers or different operators with the AS 101 and SCS 102 being operated at application level while the MON 104 being operated at network level. The control traffic between an AS 101 and a MON 104 are transmitted through one or more SCS 102 while the data traffics are transmitted directly between the AS 101 and the MON 104. For the second Hybrid Model 118 in which both SCS 102 and MON 104 are operated at network level. The control traffic between an AS 101 and a MON 104 are transmitted through one or more SCS 102 while the data traffics are transmitted directly between the AS 101 and the MON 104.

Since a SCS 102 may either belong to the same mobile operator network MON 104 domain at network level 130 or has access authority to the MON 104 through subscription, a SCS 102 may have knowledge of one or more interworking MON 104, and may have knowledge of the MTC features and/or the MTC functional capabilities provided by each interworking MON 104, and may have knowledge of the configurations of the MTC features agreed to by each interworking MON 104, and may have knowledge of the configurations of the MTC functional capabilities agreed by each interworking MON 104. A SCS 102 essentially represents an intermediary functional support between an AS 101 and a MON 104. As an AS 101 may connect to one or more SCSs 102, a single SCS 102 may yet connect to one or more MONs 104, and therefore both an AS 101 and a SCS 102 may have accesses to one or multiple MONs 104. A SCS 102 performs delivering MTC services related control and/or data traffics and providing functional supports. In addition, a SCS 102 may find inter-working pairs between an AS 101 and a MON 104 according to their required and provided MTC features, MTC functions and capabilities, and a SCS 102 may perform supplement or translate certain MTC functions and/or MTC functional capabilities if necessary.

FIG. 1B illustrates an example of a MTC network architecture. Please note that the quantities of MTC components in FIG. 1B as well as the remaining figures are for the convenience of elucidation and thus do not constitute restrictions for the embodiments of the present disclosure. The MTC network architecture under the example contains a pair of application servers (AS) 101 with one connected directly to MON_{—}1 104a with the other indirectly connected to MON_{—}2 104b and MON_{—}3 104c through the SCS_{—}1 102a. The SCS_{—}1 102a may connect to another SCS, namely, SCS_{—}2 102b, thus to enable the interconnection between SCS_{—}1 102a and MON_{—}3 104c. The SCS_{—}1 102a may connect to the MON_{—}2 104b and may also connect to MON_{—}3 104c via SCS_{—}2 120b so that AS 101 may have network access to MON_{—}2 104b and MON_{—}3 104c at the same time, and thus an AS 101 may have network access to MTC UEs which may belong to different MONs 104.

Each MON may contain a different MTC Interworking Function (IWF) 103. An IWF 103 is a logical construct representing MTC features and/or functions supported by each MON. An IWF 103 could also represent a network interface of a MON 104 and supplies a plurality of protocols for communications between the MON 104 and elements connected to the MON 104, also represent a network interface of a MON 104 to interconnect and intercommunicate between network elements (e.g. HSS, SGSN, SMS-SC, PDN-GW, etc.) within the MON 104.

Each MON 104 may connect to MTC UEs/MTC devices 105 individually or as a group. Since the sheer quantities of MTC UEs 105 could potentially be astronomical, control signals overhead can be saved if a control signal is transmitted to UEs 105 as a group instead of having a control signal as dedicated for an individual UE. However, if not all UEs within a group can satisfy a group functional requirement, unnecessary re-transmission and/or error signals could be the end result. Therefore, the prevention of network congestion or overload caused by unnecessary control signals calls for a strategy to control MTC UEs 105 as a group. Furthermore, if functions required by a MTC AS 101 is inconsistent with the functions supported by a MON 104, and also if functional inconsistencies also exist between UE 105 groups and MONs 104, error signals or re-transmission request could also be produced and in turn congest a network or induce un-expected responses of a network (e.g. re-transmissions may bring about the issues of duplicate or disordered requests).

The situation of functional inconsistency may further complicate because a MTC UE may relocate from a network to another network (i.e. from MON_{—}1 104a to MON_{—}2 104b. Functional inconsistency on the network level 130 can occur because MON_{—}2 104b does not possess all the functions required by a MTC application which is normally delivered by MON_{—}1 104a. Also MON_{—}2 104b might have a different network capacity from MON_{—}1 104a, or the functional settings or parameters of MON_{—}2 104b might be different from MON_{—}1 104a. Also even if MON_{—}2 104b contains all the required functions as well as network capacities, a roaming user might not have the access privilege due to the lack of subscription. Therefore, before AS 101 transmits a group based application service request, the present disclosure take the functions, capabilities, and locations of MTC devices 105 as well as the functions and capabilities of serving MONs 104 into consideration before providing MTC services to a group. In other words, the present disclosure is aimed to ensure functional consistency on both the application level 120 and the network level 130 in order to prevent unexpected network response by the way of group based MTC function translations and adjustments.

In order to mitigate the problems of error signals and re-transmissions due to group based functional inconsistencies, FIG. 1C illustrates a concept of group based MTC network architecture in accordance with the present disclosure. Suppose AS 101c in FIG. 1C requires a set A of MTC functions which is referred as function set A hereafter and provides MTC services to a plurality of UEs. First, the AS 101c could group the plurality of UEs according to home or serving mobile operator networks. After, UEs are separated into two groups based on their home or serving mobile operator networks, MON_{—}1 104a and MON_{—}2 104b, each home mobile operator network could further group the MTC UEs according to the functions the UEs are capable to provide. For the simple illustration of FIG. 1C, the MON_{—}1 104a further group MTC UEs as MTC UE group 105a with a set A of MTC functions (function set A) and MTC UE group 105b with the capabilities of a set B of MTC functions which is referred as function set B hereafter. MON_{—}2 104b also further group MTC UEs as UE group 105c with function set A and MTC group UEs 105d with the capabilities of function set B.

Suppose MON_{—}1 104a could also support function set A, then MTC UE group 105a could operate without error signals as the result of a functional inconsistency. However, MTC UE group 105b does not share the function set A but instead possesses MTC capabilities of function set B, which may be different from function set A. Then, there could be several options. In the case that function set B is a subset of function set A, and the MTC features and/or MTC functions required by the AS 101c can be performed and fulfilled by function set B, one option could be for MON_{—}1 104a to supply the MTC UE group 105b with function set B, if possible, so that there would no longer be functional inconsistencies between MTC UE group 105b and AS 101c. One option could be for the AS 101 to temporarily deactivate certain features on UEs of the MTC UE group 105b that can not be fulfilled by function set B, so that only MTC requests and/or MTC features that can be performed and fulfilled by function set B are delivered to the MTC UE group 105b to prevent unnecessary error messages and/or re-transmissions.

In the case that function set B is different from function set A, one option could be for MON_{—}1 104a to perform a functional translation from function set A into function set B, if possible (e.g. one or more functions can be substituted by other one or more functions, one or more functions can be fulfilled by other one or more functions but with limitations, etc.), so that there would no longer be functional inconsistencies between MTC UE group 105b and AS 101c. Or else, for example with the assistance of MON_{—}1 104a the AS 101c could temporarily de-activate the MTC service and/or MTC features on UEs of the MTC UE group 105b so as to prevent or minimize unnecessary error messages and/or rejection signals and/or re-transmissions.

Another possible solution would be for the SCS 102c to perform functional adjustments and translations by routing the transmission for MTC group 105c and 105d through the SCS 102c. Since the AS 101c can connect directly to MON_{—}1 104a or indirectly through the SCS 102c, the AS 101c could be aware of the MTC capabilities of the SCS 102c, including the MTC features and/or MTC functions provided by SCS 102c, and/or the configurations of the MTC features and/or MTC functions supported by SCS 102c. The AS 101c could be aware of the MTC capabilities of the MON_{—}1 104a which is directly interconnected with the AS 101c and may be aware of the MON_{—}2 104b which is indirectly interconnected with the AS 101c. The SCS 102c could be aware of the MTC capabilities of the MON_{—}1 104a and the MON_{—}2 104b, including the MTC features and/or MTC functions provided by MON_{—}1 104a and MON_{—}2 104b, and/or the configurations of the MTC features and/or MTC functions supported by MON_{—}1 104a and MON_{—}2 104b. Based on the awareness of the MTC features and/or MTC functions provided by the interworking Ass and MONs, and/or the configurations of the MTC features and/or MTC functions provided by the interworking ASs and MONs, the services of the SCS 102c could be utilized to provide functional adjustments and translations of MTC features and MTC functions.

FIG. 1D illustrates one of the concepts of group based MTC network architecture in accordance with the present disclosure. Suppose that MON_{—}1 104a could support function set A, MON_{—}2 104b could support function set B. Assuming that MTC UEs under the service region of MON_{—}1 104a are grouped into MTC UE group 105a and MTC UE group 105c according to the MTC capabilities provided by each MTC UE. MTC UE group 105a is capable of function set A, and MTC UE group 105c is capable of function set B. Assuming that MON_{—}1 104a is both accessible to and can be subscribed by MTC UE groups 105a and 105c. Assuming that MTC UEs under the service region of MON_{—}2 104b are grouped into MTC UE group 105b and MTC UE group 105d according to the MTC capabilities provided by each MTC UE. MTC UE group 105b is capable of function set A, and MTC UE group 105d is capable of function set B. MTC UE group 105b and 105d could be served by AS 101c through MON_{—}2 104b which is capable of function set B, assuming that MON_{—}2 is both accessible to and can be subscribed by MTC UE group 105b and 105d. The AS 101c under this scenario would be required to perform a functional selection and adjustment and/or translation so that MTC service requests can be performed by MON_{—}1 104a and MON_{—}2 104b accordingly. In the case that function set B is different from function set A, one option could be for MON_{—}1 104a and MON_{—}2 104b to perform a functional translation between function set B and function set A, if possible (e.g. one or more functions can be substituted by other one or more functions, one or more functions can be fulfilled by other one or more functions but with limitations, etc.), so that there would no longer be functional inconsistencies between MTC UE groups and MONs. Or else, for example with the assistant of MON_{—}1 104a and MON_{—}2 104b the AS 101c could temporarily de-activate the MTC service and/or MTC features on UEs of the MTC UE groups 105c and 105b so as to prevent or minimize unnecessary error messages and/or rejection signals and/or re-transmissions.

FIG. 1E illustrates one of the examples of group based MTC network architecture in accordance with the present disclosure. For this example, the MTC application service is divided into a MTC service delivered to MTC UEs using the Apple platform, and a MTC service delivered to MTC UEs using the Android platform. The AS 101d would provide the Apple system based MTC services, and the AS 101e would provide the Android system based MTC services. First from the view point of ASs, the MTC UEs 105e, 105f, 105g, 105h for this example could be divided into two groups according to their serving MONs. When AS 101d tends to serve subscribed UEs with Apple platform based MTC services, the AS 101d determining the Apple MTC service subscribers are served by MON_{—}1 104a and MON_{—}2 104b, AS 101d sends MTC service requests to Apple based MTC service subscribers via MON_{—}1 104a and MON_{—}2 104b. From the view point of MONs, MON_{—}1 104a and MON_{—}2 104b would then each further divide UEs into an Apple group (105e in MON_{—}1 104a and 105g in MON_{—}2 104b) and other group (105f in MON_{—}1 104a and 105h in MON_{—}2 104b) and deliver the MTC service request from AS 101d to 105e and 105g respectively. Similarly, when MON_{—}1 104a and MON_{—}2 104b determine a MTC service request from the AS 101e targeting to serve Android clients, MON_{—}1 104a and MON_{—}2 104b would then each further divide UEs into groups 105f and 105h respectively and deliver the MTC service request from AS 101e to 105f and 105h respectively.

FIG. 1F illustrates one of the examples of functional adjustments and translations in accordance with the present disclosure. In case of a mismatch in the functions or capabilities among an AS, a MON, and/or a group of UEs, one solution is performing a functional translation if possible. The MTC AS 101f and a group of MTC UEs (MTC UE 105j) of FIG. 1F require function set A while the MON 104 would support function set B. For example, MTC AS 101f and MTC UE 105j support function set A which could be a Small Data transmission which requires the support of specific protocols and message procedures, interfaces (e.g. Tsp and/or T5 interfaces, etc.) between network elements (e.g. IWF, SCS, MME, MSC, SGSN, etc.) of a MON. However, the MON 104 could only transmit data under short message service (SMS) format. Under this circumstance, a functional translation back and forth from function set A (e.g. Small Data Transmission) into a function set B (e.g. SMS) or from function set B into function set A could be performed by a MON 104, by the AS 101f, or by a SCS so that functional consistency between the network level 130 and on the application level 120 could be satisfied.

FIG. 1G illustrates one of the examples of functional adjustments and translations in accordance with the present disclosure. For this example, the possibility of a group of mobile MTC UEs (MTC UE 105j) is considered. The AS 101f supplies MTC services to the MTC UE 105j normally through MON_{—}1 104a, which is the subscription/home mobile operator network for the MTC UE 105j. In that case, both the AS 101f and the MTC UE 105j are capable of function set A. However, when the MTC UE 105j migrates to a visiting/roaming network, MON_{—}2 104b, MON_{—}2 104b could not support the entire function set A for being short of some required functions or for the limitations to roaming users but instead could only support function set B, which is a subset of function set A. Under that circumstance, the AS 101f or MON_{—}1 104a may perform a functional translation between function set A and function set B, if possible. Or else, for example with the assistant of MON_{—}1 104a and MON_{—}2 104b the AS 101f or the MON_{—}1 104a or the MON_{—}2 104b could temporarily de-activate the MTC service and/or MTC features on the MTC UE 105j so as to prevent or minimize unnecessary error messages and/or rejection signals and/or re-transmissions.

For example, the AS 101f is an eHealthCare server, and MTC UE 105j are one or more mobile devices with a person to monitor vital signs. Function set A required by the eHealthCare server may include functions (e.g. packet data transmission, short message service, DRX/DTX cycle adjustment, high priority messaging, etc.) to support MTC features (e.g. small data transmission, low power consumption control, normal priority MTC messaging, etc.) that are utilized to perform heart rate monitoring, prescription reminding, a hospital visitation notice, an illness outbreak warning, and an instantaneous call for help. If function set A can be fully supported by MON_{—}1 104a, but MON_{—}2 104b would not support some of the features (e.g. normal priority MTC messaging) and/or functions (e.g. high priority messaging) to roaming MTC UE 105j, then MTC UE 105j is not capable of the instantaneous call for help service in the visiting network MON_{—}2 104b. Then the AS 101f may temporarily deactivate the instantaneous call for help on MTC UE 105j until a change in the circumstance.

FIG. 1H illustrates one of the examples of functional adjustment and translation in accordance with the present disclosure. For this example, the possibility of a group of mobile MTC UEs 105j is also considered. The AS 101f supplies MTC services to the MTC UE 105j normally through MON_{—}1 104a, which is the subscription/home mobile operator network for the MTC UE 105j. In that case, both the AS 101f and the MTC UE 105j are capable of function set A. When the MTC UE 105j migrates to a visiting/roaming network MON_{—}2 104b, MON_{—}2 104b does not provide the same configurations of MTC features and/or MTC functions (e.g. the limitation of bandwidth, bit rate, maximum payload, maximum connection, etc.) as MON_{—}1 104a. In that case, functional configurations/parameters of the MTC service has to be adjusted (e.g. to depress the maximum transmission bit rate between AS 101f and 105j, or to decrease and/or concise the volume of transmitted payloads, etc.) in order to fulfill the limitations and to meet the allowance of network capacity of MON_{—}2 104b.

FIG. 1I illustrates an overall process flow chart in accordance with the present disclosure. In order to respond to the needs of grouping MTC devices while preventing the negative consequences made by group MTC operations in terms of error signals or re-transmission requests, the present disclosure is premised upon these proposed concepts to be described as follows. On the application level 120, the MTC AS and/or SCS in step S151 would gather information related to the MTC features and/or MTC functions required by each MTC service provided by the MTC AS; and the information related to the networks interconnect with the MTC AS and/or SCS, including the MTC features and/or MTC functions provided by the interconnected one or more MONs, the configuration and/or parameter settings or capacities available of the interconnected one or more MONs, the home and/or the serving MON of each MTC device. The MTC AS may further gather the information related to the MTC capabilities (e.g. the MTC features and/or functions supported by the MTC device, the configurations and parameters of each MTC features and/or MTC functions, the supported radio access technologies, etc.) of each MTC device. In step S152, the MTC AS may group MTC devices according to the serving MON or the home MON of the MTC devices. In step 153, the MTC AS group/re-group MTC devices based on the MTC features and/or MTC functions each MON may support. In S154, before sending out MTC service requests to MTC devices, the MTC AS may translate or adjust the functions and/or the configurations/parameters of the MTC features and/or MTC functions required by the MTC services if necessary.

On the network level 130, a MON or a SCS in step S161 would gather information related to the interworking/interconnected MTC AS and/or SCS, including the MTC features and/or MTC functions required by the interworking/interconnected MTC AS and/or SCS, and the configuration and/or parameter setting of the MTC features and/or MTC functions required by the MTC AS and/or SCS. A MON or a SCS in step S161 would gather information related to the MTC devices subscribed/registered to the service domain of the MTC AS and/or SCS, including the MTC capabilities (e.g. the MTC features and/or functions supported by the MTC device, the configurations and parameters of each MTC features and/or MTC functions, the supported radio access technologies, etc.) and the communication network level location and geographical location of each MTC device. In step S162, a MON may group/re-group MTC devices according to the functions and capabilities supported by the MTC devices. In step S163, the MON may re-group MTC devices according to the network-level location (e.g. routing area RA, tracking area TA, location area LA, etc.) or geographic location (e.g. geographical coordinates of Global Positioning System GPS, etc.) or the serving/supporting radio access technologies (e.g. E-UTRA, UTRA, GERA, etc.) or the serving network systems (e.g. EPS, HSPA, HSPA+, UMTS, GSM, etc.) of the MTC devices. In step S164, before sending out MTC service requests, the MON may translate or adjust the MTC features and/or MTC functions, or adjust the configuration and/or parameter settings of MTC features and/or MTC functions required by the MTC service requests according to the capabilities of MTC devices if necessary. More specific details are to be presented by specific embodiments.

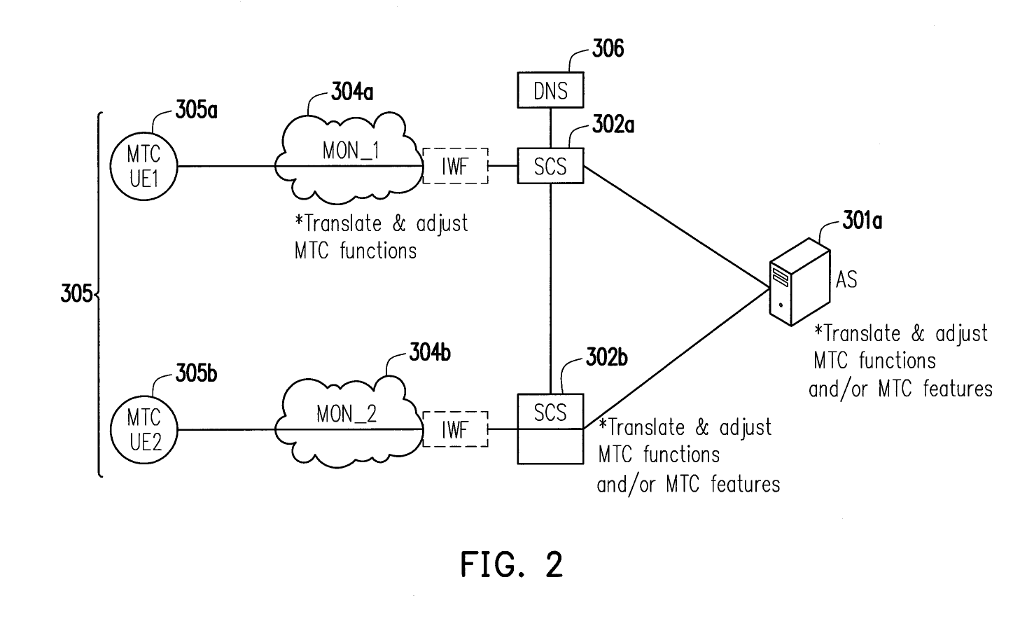

FIG. 2 illustrates one of the exemplary embodiments of group based MTC without mobility in accordance with the present disclosure. The MTC network includes at least one server MTC AS 301a which provides MTC services to group based MTC UEs MTC UE1 305a and MTC UE2 305b which subscribed to the services provided by AS 301a through networks MON_{—}1 304a and MON_{—}2 304b respectively. MTC UE1 305a and MTC UE2 305b posses the same MTC capabilities (i.e., posses the same MTC features and MTC functions, but may have different configurations and/or parameters of the MTC features and/or MTC functions). MON_{—}1 304a and MON_{—}2 304b may gather information related to MTC UE1 305a and MTC UE2 305b respectively, including the MTC capabilities (e.g. the MTC features and/or functions supported by the MTC device, the configurations and parameters of each MTC features and/or MTC functions, the supported radio access technologies, etc.) and the communication network level location and geographical location of each MTC device of MTC UE1 305a and MTC UE2 305b. SCS 302a connects with MON_{—}1 304a and SCS 302b and has the authority (e.g. under contracts or be operated by the same operator) to communicate with MON_{—}1 304a and SCS 302b. SCS 302a may also communicate with MON_{—}2 via SCS 302b, and SCS 302b may also communicate with MON_{—}1 304a via SCS 302a. SCS 302a may gather information related to the interworking/interconnected MON_{—}1 304a and/or MON_{—}2 304b and/or SCS 302b, including the MTC features and/or MTC functions provided and/or supported by the interworking/interconnected MON_{—}1 304a and/or MON_{—}2 304b and/or SCS 302b, as well as gather information related to the interworking MTC AS 301a including the MTC features and/or MTC functions, and the configuration and/or parameter setting of the MTC features and/or MTC functions required by the MTC AS 301a. The SCS 302b connects with MON_{—}2 304b and SCS 302a and has the authority (e.g. under contracts or be operated by the same operator) to communicate with MON_{—}2 304b and SCS 302a. SCS 302b may also communicate with MON_{—}1 304a via SCS 302a, and SCS 302b may gather information related to the interworking/interconnected MON_{—}2 304b and/or MON_{—}1 304a and/or SCS 302a, including the MTC features and/or MTC functions provided and/or supported by the interworking/interconnected MON_{—}2 304b and/or MON_{—}1 304a and/or SCS 302a, as well as gather information related to the interworking MTC AS 301a including the MTC features and/or MTC functions, and the configuration and/or parameter setting of the MTC features and/or MTC functions required by the MTC AS 301a. The MTC AS 301a has the authority (e.g. under contracts or be operated by the same operator) to access SCS 302a and SCS 302b, therefore MTC AS 301a can obtain communication services from MON_{—}1 304a and MON_{—}2 304b via SCS 302a and/or SCS 302b. The MTC AS 301a may gather the information related to the MTC capabilities (e.g. the MTC features and/or functions supported by the MTC device, the configurations and parameters of each MTC features and/or MTC functions, the supported radio access technologies, etc.) of MTC UE1 305a and MTC UE2 305b. Also all or some of the MONs could interconnect on their own (e.g. based on the contract).

Before sending out a service request to SCS or MON, the AS 301a could translate and adjust MTC features and/or MTC functions required by the MTC service to ensure functional consistencies between the serving MONs (e.g. MON_{—}1 304a and MON_{—}2 304b) and/or SCS (e.g. SCS 302a and SCS 302b) and the AS 301a.

In some cases (e.g. MTC devices are assigned with IPv4/IPv6 address) the current location and the current identity and/or IP addresses could be maintained in Domain Name System (DNS) Server DNS 306, the SCS 302a and 302b have the ability to query DNS for the current location and current identify and/or IP addresses of MTC devices. In the case when the serving SCS of a group of MTC devices has exceeded the agreed/allowable maximum data transmission volume of the serving network, the MTC AS may choose alternative one or more SCSs for providing MTC services to MTC devices. For example when AS 301a intends to provide MTC services to MTC UE1 305a by transmitting data to MTC UE1 305a, however the serving SCS 302a of MTC UE1 305a has exceeded the maximum data transmission volume agreed/allowed by MON_{—}1 304a the serving MON of MTC UE1 305a. In the case the MTC AS 301a consults the reference data including the interworking SCS/MON information of MTC AS 301a, and the route (SCS/MON) selection polices for MTC AS 301a to determine the one or more candidate alternative routes (e.g. MTC AS 301a could send out MTC service requests to MON_{—}1 via SCS 302b instead of SCS 302a to avoid/dodge the exceeding of maximum data volume in SCS 302a) to transmit the data of MTC services from MTC AS 301a to MTC UE1 305a.

On the network level, the MON_{—}1 304a, MON_{—}2 304b, SCS 302a, SCS 302b could also perform functional adjustments and translations including the translations and adjustments of MTC features and/or MTC functions, and/or the adjustments of the configurations and/or parameters of the MTC features and/or MTC functions.

On the application server level, AS 301a would first group MTC UEs into MTC UE1 305a and MTC UE2 305b according to their serving networks MON_{—}1 304a and MON_{—}2 304b, respectively. Before delivering MTC service requests, for each group of MTC UEs (i.e. MTC UE1 305a and MTC UE2 305b in this example), the AS 301a would determine a candidate SCS (i.e. SCS 302a or SCS 302b in this example) and/or a candidate MON which can be utilized to communicate with the group of MTC UEs and determine whether the SCS/MON is capable of performing all the MTC features and/or MTC functions required by the MTC service request. If the SCS/MON for the group is capable, then the AS 301a would perform the MTC service by considering the group is a minimal unit. However, if certain required MTC features and/or MTC functions are not capable or available for a SCS/MON, then the server 301a might translate and/or adjust the required MTC features and/or MTC functions to achieve functional consistency with MONs, or the MTC AS 301a might deactivate the service temporarily.

On the network level, the serving MON (304a for MTC UE1 305a and 304b for MTC UE2 305b) may group/re-group MTC devices according to the functions and capabilities supported by the MTC devices (MTC UE1 305a and/or MTC UE2 305b). MONs may re-group MTC devices according to the network-level location (e.g. routing area RA, tracking area TA, location area LA, etc.) or geographic location (e.g. geographical coordinates of Global Positioning System GPS, etc.) or the serving/supporting radio access technologies (e.g. E-UTRA, UTRA, GERA, etc.) or the serving network systems (e.g. EPS, HSPA, HSPA+, UMTS, GSM, etc.) of the MTC devices. Before sending out MTC service requests, MON_{—}1 304a and/or MON_{—}2 304b may translate or adjust the MTC features and/or MTC functions, or adjust the configuration and/or parameter settings of MTC features and/or MTC functions required by the MTC service requests according to the capabilities of MTC devices (MTC UE1 305a and/or MTC UE2 305b) if necessary.

Referring to FIG. 2 for more specific example, the MON_{—}1 304a would detect whether the MTC features and/or MTC functions as provided by the network are within the possession and capability of the group of MTC devices MTC UE1 305a. If all MTC devices of the MTC UE1 305a are functionally capable of performing functions provided by MON_{—}1 304a, then MON_{—}1 may check to see if the MTC group 305a has exceeded the threshold of the MON_{—}1 304a. If the threshold is not exceeded, then the MON_{—}1 304a would provide the MTC functions to the UE. The threshold could be, for instance, maximum bit rate, maximum number of connections, maximum total volume of data transmission, and so like, in order to ensure the network does not exceed its limit.

However, if the MTC devices group MTC UE1 305a and/or MTC UE2 305b as a whole fails to meet the functional demand of MON_{—}1 304a and/or MON_{—}2 304b (i.e. MTC UE1 305a and/or MTC UE2 305b individually or collectively falls short of the MTC features and/or MTC functions required and/or expected by MON_{—}1 and/or MON_{—}2, respectively), then MON_{—}1 304a and/or MON_{—}2 304b may translate and/or adjust the MTC features and/or MTC functions, or adjust the configuration and/or parameter settings of MTC features and/or MTC functions required by the MTC service requests for MTC devices (MTC UE1 305a and/or MTC UE2 305b) if necessary.

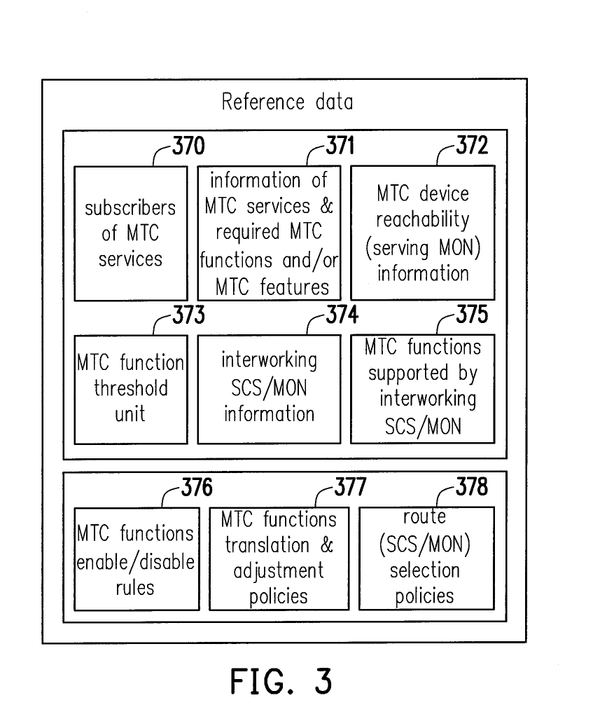

It should be noted that before group based MTC with functional adjustment or translation could be implemented, related network information for group based MTC must be collected and maintained. FIG. 3 illustrates reference data to be collected and maintained by AS or SCS on application level. The reference data includes at least but not limited to subscribers of applications 370, information of application and required MTC functions 371, subscriber reachability and serving MON information 372, MTC function threshold 373, interworking SCS/MON information, MTC functions supported by Interworking SCS/MON. The subscriber reachability information 372 may be obtained from the serving MON or SCS of a subscriber, or it may be obtained from DNS information, or in some situations may only be transmitted from a voluntary transmission by a subscriber. The MTC function threshold 373 helps determines whether a group based MTC in the service domain of a MON has reached its threshold. The Interworking SCS/MON information 374 could be available when an AS subscribes to a MON or SCS.

The reference data may also include rules and policies which may include at least these followings but not limited to MTC features and MTC functions enable and disable rules 376, MTC features and MTC functions translation and adjustment policies 377, and route (SCS/MON) selection policies 378. The MTC function translation and adjustment policies 377 may include guidance and rules of whether MTC feature and/or MTC function adjustments and translations may be performed, the substitution and/or combinations of MTC features and/or MTC functions and the related parameters and/or configurations required for functional changes. It may also include the guidance and rules of whether MTC features and/or MTC functions may be separated, and whether MTC groups may be sub-divided into sub-groups by separating functions further.

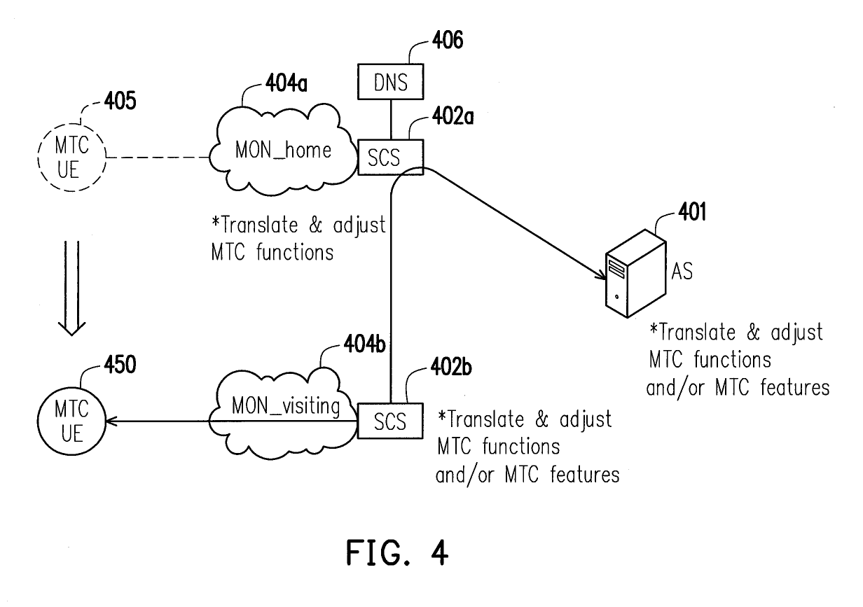

MTC could involve subscribers which may be mobile. When a MTC UE migrates from one location to another location, the MTC UE could leave the service domain of a MON and move to the service domain of a different MON. The MON which provides services to a roaming MTC UE could impose different availability of MTC capabilities (including MTC features and/or MTC functions, and the configuration and/or parameter settings of the MTC features and/or MTC functions) due to subscriptions or the lack thereof, or the abilities of some MTC features and/or MTC functions, or the limitations to visiting MTC devices, and etc. FIG. 4 illustrates group based MTC with mobility in accordance with one of the exemplary embodiments of the present disclosure. Some of the concepts which could be recognized by an ordinary person skilled in the art as similar to the case without mobility will not be repeated. Suppose that a group of MTC devices the MTC UE 405 migrates from MON_home 404a to MON_visiting 404b. When the migration occurs, the MTC service could be delivered through interconnecting MONs and be re-routed through a different path.

For the example of FIG. 4, the SCS 402a interconnecting with MON_home 404a and SCS 402b interconnecting with MON_visiting 404b are interconnected. In the case when the group of MTC devices MTC UE 405 move from MON_home 404a to MON_visiting 404b and new network identities and/or addresses are given to the group of roaming MTC devices MTC UE 450 by MON_visiting 404b, the latest identities and the serving network of the roaming MTC devices are updated to and maintained in DNS 406. Before sending out a service request to MON_home 404a, SCS 402a and/or 402b may query DNS 406 for the current identities/addresses and the current serving MON of the MTC devices. SCS 402a learns from DNS 406 that MTC UE 405 has moved to the service domain of MON_visiting 404b and obtains the latest identities/addresses of MTC UE 450, the SCS 402a could translate and adjust MTC features and/or MTC functions required, and the configuration and/or parameter settings of the MTC features and/or MTC functions to fulfill the capabilities of SCS 402b and/or MON_visiting 404b, to ensure functional consistencies between the serving MONs (e.g. MON_home 404a and MON_visiting 404b) and/or SCS (e.g. SCS 402a and SCS 402b) and the AS 401. AS 401 could choose alternative route from the interconnecting SCS between SCS 402a to SCS 402b and reach the MTC UE 450 through the MON_visiting 404b. When the MTC capabilities are inconsistence between SCS 402b and MON_visiting 404b, the SCS 402b may translate and adjust MTC features and/or MTC functions required by SCS 402a, and the configuration and/or parameter settings of the MTC features and/or MTC functions to fulfill the capabilities of MON_visiting 404b, to ensure functional consistencies between the serving MON_visiting 404a and/or SCS 402b and the AS 401.

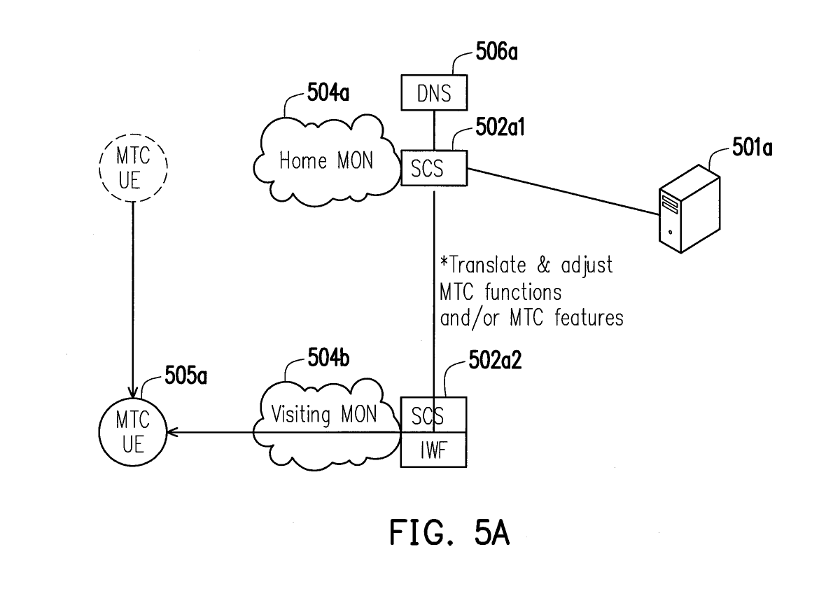

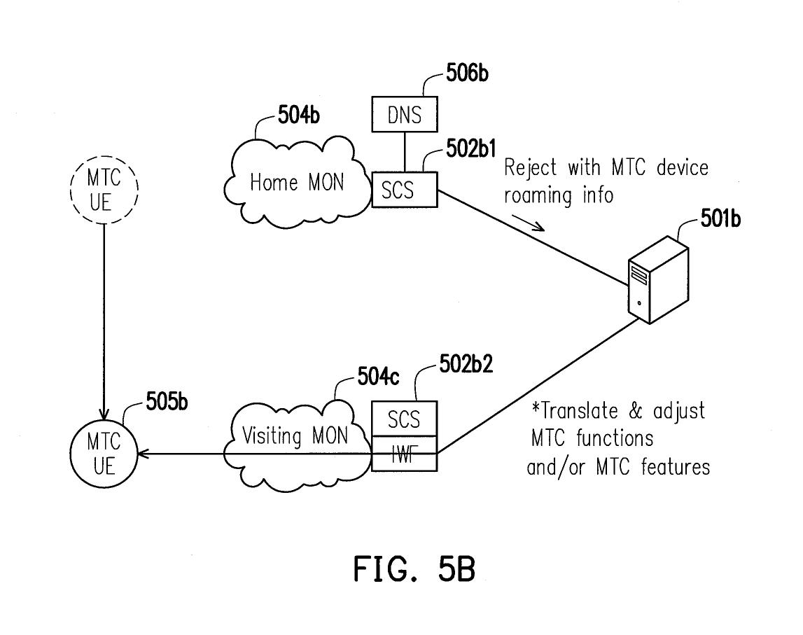

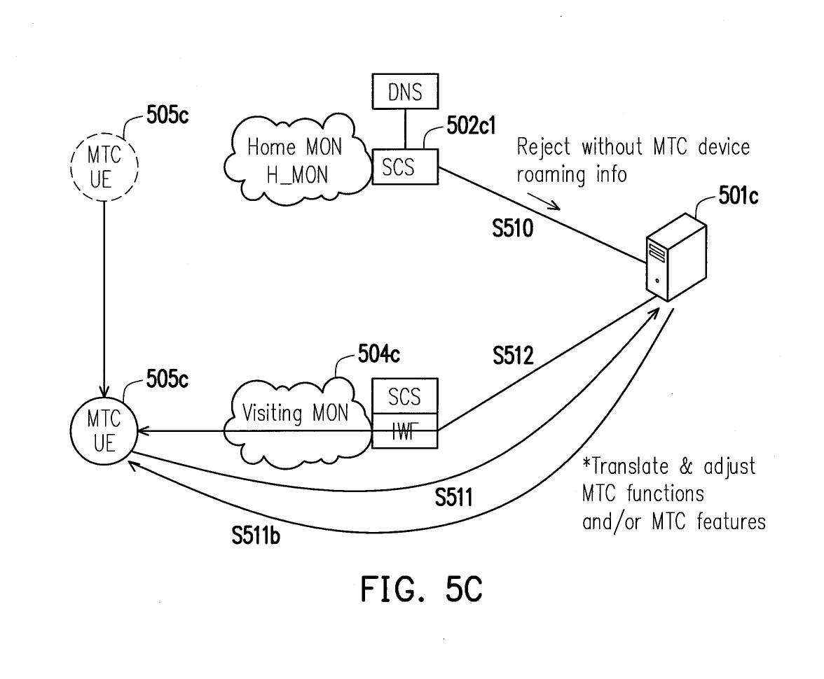

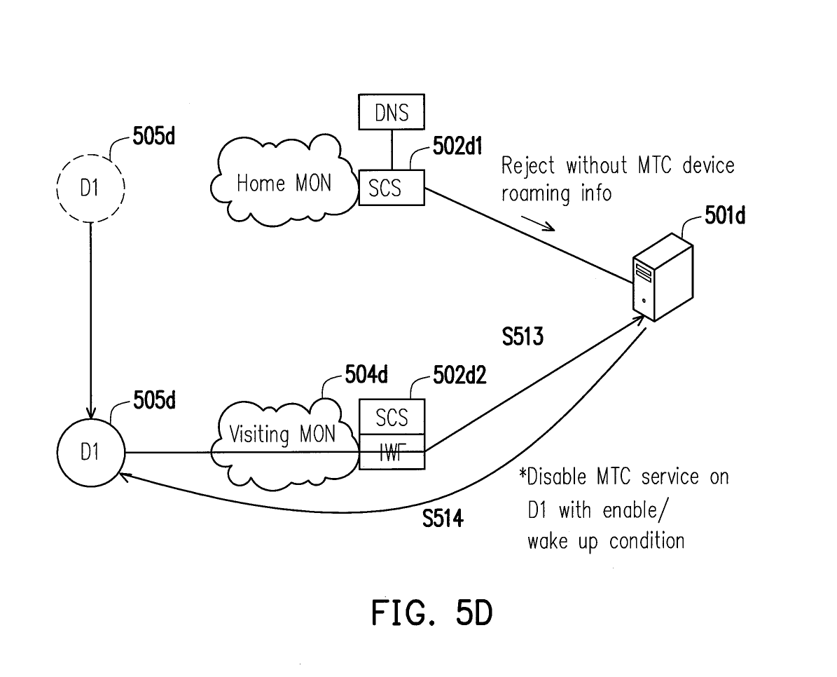

FIGS. 5A-5D provide four specific examples of group based MTC devices with mobility. FIG. 5A illustrates one of the possible scenarios of group based MTC with mobility in accordance with one of the exemplary embodiments of the present disclosure. Suppose that the MTC UE 505a is a group of MTC devices with mobile capabilities, and the AS 501a is an MTC server which provides MTC services without human intervention. Assume that MTC UE 505a has moved to Visiting MON 504b which has the authority to intercommunicate with Home MON 504a. However, Visiting MON 504b sets limitations to roaming devices (may not be specific to MTC UE 505a) such that some of the allowable MTC features and/or MTC functions in Home MON 504a for MTC UE 505a may turn to be not available in Visiting MON 504b. If the AS 501a could not gather the reachability information (e.g. the serving MON information) of subscribed MTC devices (MTC UE 505a), according to that Home MON 504a is the home MON of MTC UE 505a, the AS 501a should provide MTC services to MTC UE 505a with utilizing the transmission services of the Home MON 504a via SCS 502a1. SCS 502a1 may query DNS 506a for the current reachability information of MTC UE 505a before sending out the MTC service requests from AS 501a, and SCS 502a1 may further translate and adjust MTC features and/or MTC functions regarding to the MTC capabilities of SCS 502a2 to ensure functional consistencies between the Visiting MON 504b and/or SCS 502a2 and the AS 501a, or the SCS 502a1 may response to inform AS 501a that the MTC capabilities are inconsistency between the serving MON and the MTC devices, thus MTC AS 501a might temporarily deactivate some or all of the MTC services on MTC UE 505a accordingly.

FIG. 5B illustrates another scenario of group based MTC with mobility in accordance with one of the exemplary embodiments of the present disclosure. Under this particular scenario however, the Home MON 504b does not have MTC based interconnection with the Visiting MON 504c. If a group of MTC devices MTC UE 505b has migrated from Home MON 504b to Visiting MON 504c, If the Home MON 504b could gather the reachability information (e.g. the serving MON information) of subscribed MTC devices (MTC UE 505b) via procedures assisted by UEs, including registration and/or location update related procedures (e.g. attach, registration, location area update, routing area update, tracking area update, measurement report, etc.), or the SCS 502b1 could learn the reachability information of the MTC UE 505b by querying the DNS 506b, or the reachability information could be informed directly by the visiting MON 504c or the MTC UE 505b so as to update the subscriber reachability information 372, which has been described by FIG. 3 has a part of the AS/SCS reference data under constant maintenance. After the reachability information of the MTC UE 505b has been learned by the Home MON 504b, the Home MON 504b may reject the MTC service requests from AS 501b with MTC device roaming information, which may include the reachability information of the MTC UE 505b. Thus AS 501b would be able to find an alternative route to provide the MTC services to the MTC UE 505b. For example, AS 501b could decide an alternative route based on the information as shown in FIG. 3 and determine to utilize the route via SCS 502b2 and Visiting MON 504c. AS 501b may further translate and adjust MTC features and/or MTC functions regarding to the MTC capabilities of SCS 502b2 and visiting MON 504c to ensure functional consistencies between the Visiting MON 504c and/or SCS 502b2 and the AS 501b, or if the MTC capabilities are inconsistency between the Visiting MON 504c and the MTC UE 505b, thus MTC AS 501b might temporarily deactivate some or all of the MTC services on MTC UE 505b accordingly.

FIG. 5C illustrates another scenario of group based MTC with mobility but without interconnectivity between the home MON and the roaming MON in accordance with one of the exemplary embodiments of the present disclosure. Under this scenario, the AS 501c has subscription to the visiting MON 504c. After the MTC UE 505c migrates to the visiting MON 504c, the SCS 502c1 or the Home MON however in step S510 sends a rejection signal rejecting the service request from the AS 501c but does so without sending any MTC UE roaming information. This could occur if a subscriber has deactivated a MTC UE and moves from one part of the US to another part of the US without reactivating the MTC UE. Under this circumstance, the Home MON could not send location information to the AS 501c for the subscriber reachability information 372 to be updated. The AS 501c subsequently must suspend the MTC service and wait for the MTC UE 505c to re-initiate the communication so as to avoid unnecessary error signals. When the MTC UE 505c is re-activated and re-appears in the network, and the MTC UE 505c must take the initiative to send a message to the AS 501c with a location information in step S511. The AS 501c would then translate and adjust functions in accordance with the functional capability of the visiting MON 504c and provides the MTC service through the visiting MON 504c in step S512 if the MTC UE 505c can be reachability via visiting MON 504c. Alternatively the AS 501c may provide the MTC service through the other network that the MTC UE 505c utilized in step S511 according to the route (SCS/MON) selection policies 378, or temporarily deactivate the MTC service in step S511 according to the MTC functions enable/disable rules 376 which has been described by FIG. 3 has a part of the AS/SCS reference data under constant maintenance. Alternatively the AS 501c may temporarily deactivate some or all of the MTC services on MTC UE 505c accordingly in step S512 if the MTC capabilities are inconsistency between the Visiting MON 504c and the MTC UE 505c.

FIG. 5D illustrates another scenario of group based MTC with mobility but without interconnectivity between the home MON and the roaming MON in accordance with one of the exemplary embodiments of the present disclosure. Under this scenario, the AS 501d does not have subscription to the visiting MON 504d. For example, an American could have migrated to Cuba. After the MTC UE 505d migrates to the visiting MON 504d, the SCS 502d1 however rejects the service request from the AS 501d and does so without sending any MTC UE roaming information. Under this circumstance, the AS 501d suspends the service application and wait for the MTC UE 505d to re-initiate the communication. When the MTC UE 505d takes the initiative by sending a message to the AS 501d containing a location information in step S513, the AS 501d then would then find out that it does not have subscription to the Visiting

MON 504d so that in step S514 the AS 501d disables the MTC UE 505d temporarily. The MTC UE 505d under a different circumstance could trigger the MTC service to be once again enabled.

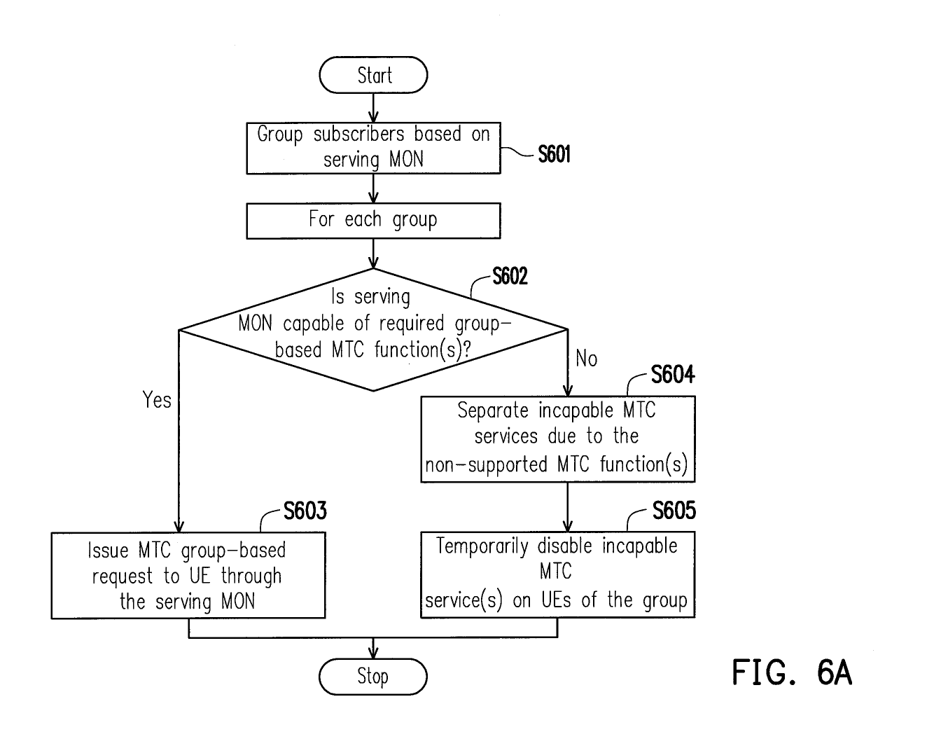

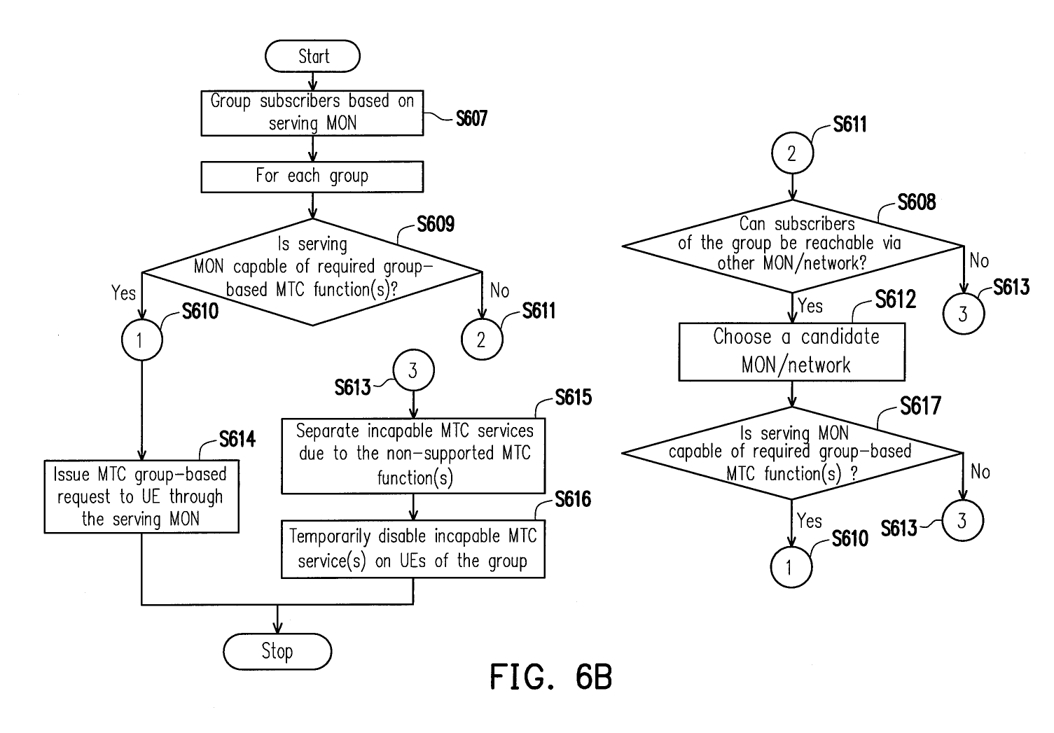

FIG. 6A is a block diagram illustrating group based MTC functions translation and adjustment from the perspective of a service provider in accordance with one of the exemplary embodiments of the present disclosure. In step S601, an AS initially group subscribers based on the serving MON of the subscribers. For each subscriber group, in step S602 the AS detects whether the serving MON is capable of all the required group based MTC features and/or MTC functions. If yes, then the process goes to step S603. In step S603, the AS anticipates no problem in the application level and issues MTC group-based request to subscribers through the serving MON. Otherwise, if the serving MON is not capable of all required group-based MTC features and/or MTC functions, then in step S604, the AS would attempt to separate incapable MTC services due to the non-supported MTC features and/or MTC functions according to reference data and policies. Next in step S605, the AS would temporarily disable MTC the part of the MTC services which cannot be carried out due to incapable MON for this particular group. It should be clarified that for this embodiment, as long as the serving MON cannot support certain functions for subscribers within the group, the serving MON would disable the incapable functions.

FIG. 6B is a block diagram illustrating another exemplary embodiment of group based MTC functions translation and adjustment from the perspective of a service provider in accordance with the present disclosure. In step S607, an AS initially groups subscribers based on the serving MON of the subscribers. For each subscriber group, in step S609 the AS detects whether the serving MON is capable of the entire required group based MTC functions. If yes, then the process goes to S610, which is a connecting point to connect between block diagrams and hence the process moves to step S614, otherwise the process proceeds to step S611 which is a connecting point to connect between block diagrams and hence the process moves to step S608. Next, if step S610 determined as yes, then in step S614, the AS anticipates no problem in the application level and issues MTC group-based request to subscribers through the serving MON. Otherwise, if the serving MON is not capable of all required group-based MTC functions, then in step S608, the AS would determine whether subscribers within the group can be reached by another MON or network.

If the subscribers within a group can be reachable via another MON/network in step S608, then AS in step S612 would choose another candidate MON/network for the subscribers which can be reached through the candidate MON. If the answer is no in step S608, then the process proceeds to step S613 which is a connecting point to connect between block diagrams and hence the process moves to step S615. In step S615, the AS would attempt to separate incapable MTC services due to the non-supported MTC functions according to reference data and policies. Next in step S616, the AS would temporarily disable the part of the MTC services which cannot be carried out due to incapable MTC capabilities of the MON for this particular group.

After the step S612 is executed, next in step S617, the AS detects if the candidate serving MON is capable of required group-based MTC functions. If yes, then the process proceeds in step S610; otherwise, the process proceeds in step S613. If the candidate serving MON is capable of required group-based MTC functions, then in step S612 the AS issues MTC group-based request to the subscribers through the candidate serving MON. If the candidate serving MON is not capable of required group-based MTC functions, then AS proceeds in step S615 and S616. It should be clarified that in steps S608, S612, and S617, which is in the case when the initial home MON does not support all the required functions, the AS would attempt to locate another MON which could deliver the incapable functions to the subscribers. If the AS could not locate another MON capable of all required functions and can reach the subscribers, then the AS would temporarily disable incapable functions only for the these subscribers for whom the suitable MON cannot be found within the subscriber group.

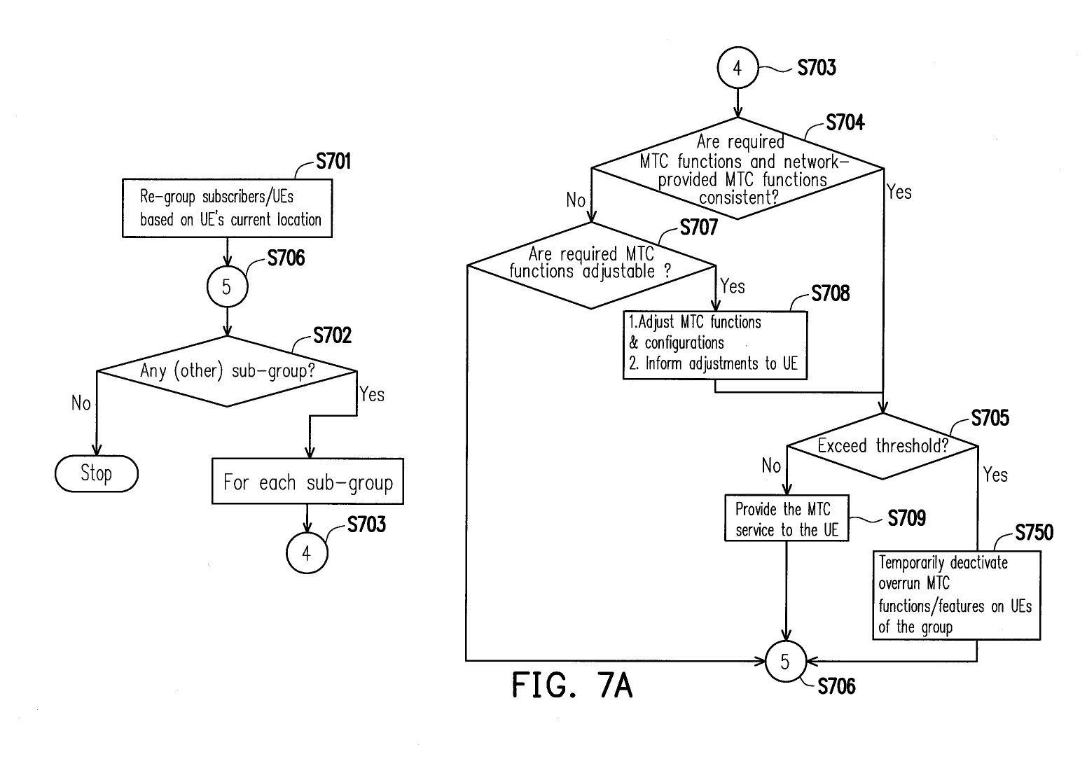

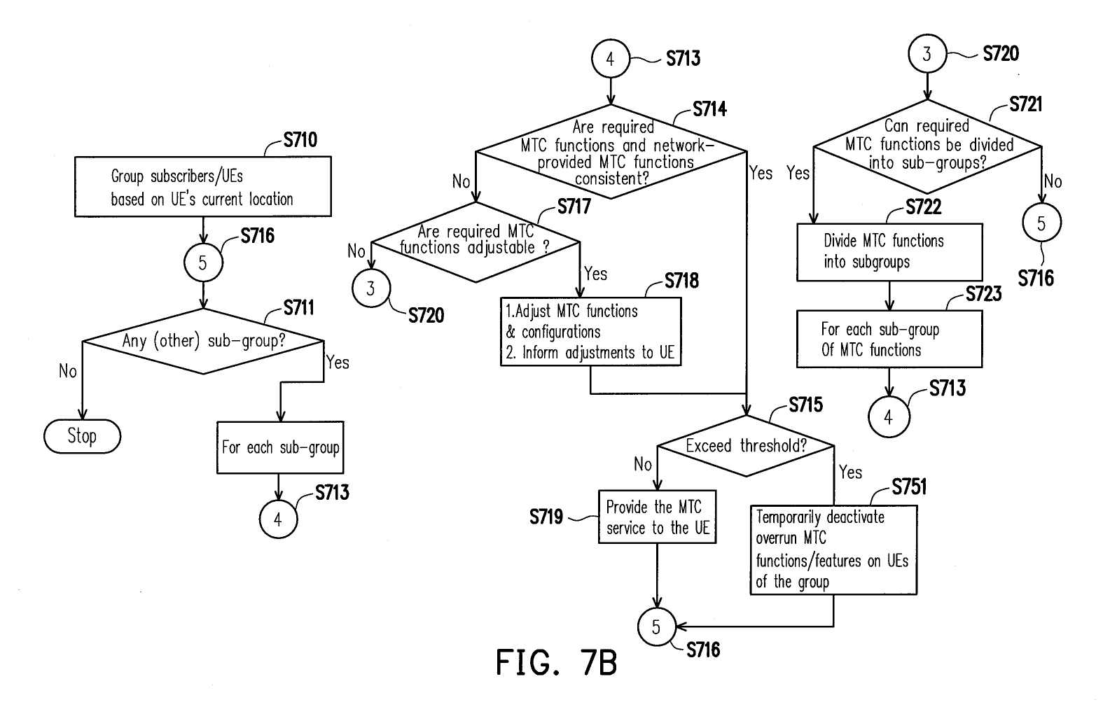

FIG. 7A is a block diagram illustrating group based MTC functions translation and adjustment from the perspective of a network in accordance with one of the exemplary embodiments of the present disclosure. In step S701, for selecting interface (e.g. T5a/b/c, T4, etc.) based on the current location of each UE, the MON groups subscribers or UEs according to the UE's current locations. A UE's current location could be determined based on the serving base station or the network level address of a UE. Next, in step S702, the MON determines whether there are anymore sub-groups of UEs to be formed. If no, the process ends. Otherwise, for each sub-group, the process proceeds to step S703 which is a connecting point to connect between block diagrams and hence the process moves to step S704. In step S704, the MON determines if the MTC functions provided by the network or MON and the functions of the UEs are consistent. If they are consistent, then the processes proceeds to step S705; otherwise the process proceeds in step S707. In step S705, the MON determines if the required MTC functions would exceeds the threshold of the network. The threshold can be determined based on parameters such as the maximum bandwidth, maximum bit rate, maximum number of connections, or maximum data transmitted or received. If the threshold exceeded, then the process moves to step S750 and then step S706 which is a connecting point to connect between block diagrams and hence the process moves to step S702. In step S750, the MON may temporarily deactivate overrun MTC function/features on UEs of the group. If the threshold is not exceeded, then in step S709 the MON provides the MTC service to the UE.

If in step S704 the MTC functions provided by the network or MON and the functions of the UEs are not consistent, then in step S707 the MON determines if required MTC functions are adjustable by the MON. If the required functions are not adjustable, then the process moves to step S706. If adjustable, then in step S708, the MON adjusts MTC functions and configurations and informs the adjustments to the UE. The process then proceeds to step S705 for the threshold check.

FIG. 7B is a block diagram illustrating another exemplary embodiment of group based MTC functions translation and adjustment from the perspective of a network in accordance with the present disclosure. In step S710, for selecting interface (e.g. T5a/b/c, T4, etc.) based on the current location of each UE, the MON groups subscribers or UEs according to the UE's current locations. A UE's current location could be determined based on the serving base station or the network level address of a UE. Next, in step S711, the MON determines whether there are anymore sub-groups of UEs to be formed. If no, the process ends. Otherwise, for each sub-group, the process proceeds to step S713 which is a connecting point to connect between block diagrams and hence the process moves to step S714. In step S714, the MON determines if the MTC functions provided by the network or MON and the functions of the UEs are consistent. If they are consistent, then the processes proceeds to step S715; otherwise the process proceeds in step S717. In step S715, the MON determines if the required MTC functions would exceeds the threshold of the network. The threshold can be determined based on parameters such as the maximum bandwidth, maximum bit rate, maximum number of connections, or maximum data transmitted or received. If the threshold exceeded, then the process moves to step S751 and then step S716 which is a connecting point to connect between block diagrams and hence the process moves to step S711. In step S751, the MON may temporarily deactivate overrun MTC functions/features on UEs of the group. If the threshold is not exceeded, then in step S719 the MON provides the MTC service to the UE.

If in step S714 the MTC functions provided by the network or MON and the functions of the UEs are not consistent, then in step S717 the MON determines if required MTC functions are adjustable by the MON. If the required functions are adjustable, then in step S718, the MON adjusts MTC functions and configurations and informs the adjustments to the UE. The process then proceeds to step S715 for the threshold check. If the required functions are not adjustable, then the process moves to step S720 which is a connecting point to connect between block diagrams and hence the process moves to step S721. In step S721, the MON determines if required MTC functions can be divided. If MTC functions can be divided, then in step S722, the MON would divide the UE group into UE sub-groups based on MTC functions. In step S723, the process repeats for each sub-group of MTC functions and loops to step S713. However, if in step S721, the MON determines that MTC functions cannot be divided into sub-groups, then the proceeds moves to step S716.

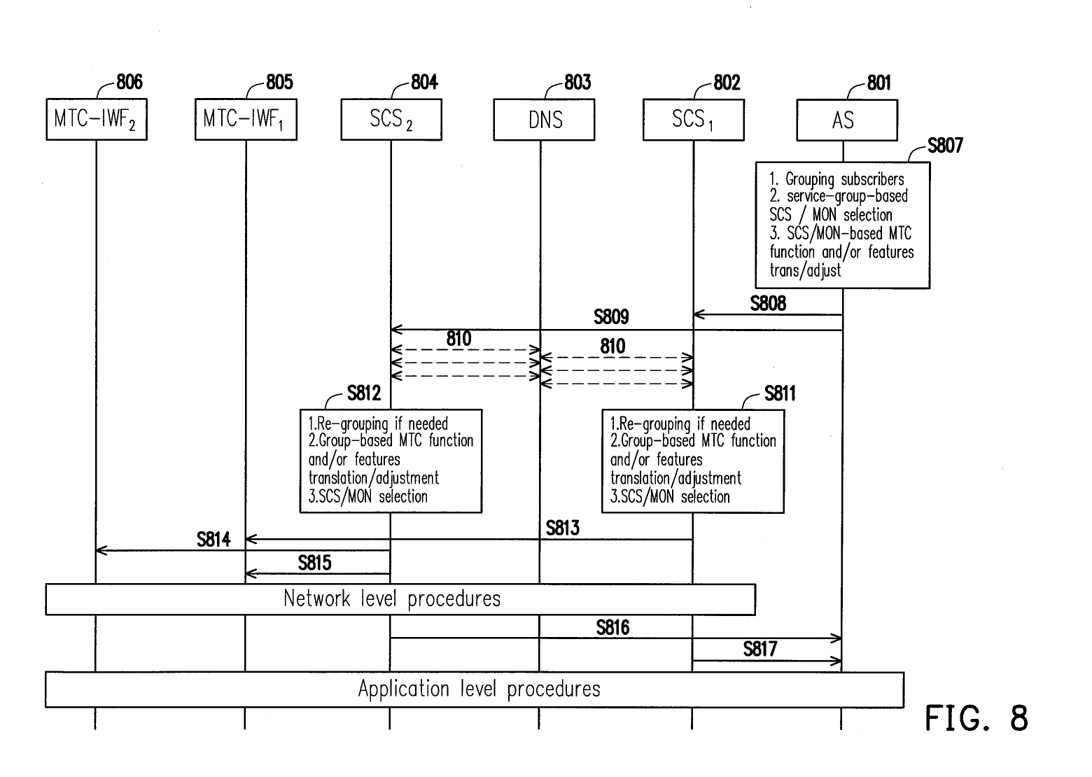

FIG. 8 illustrates a process flow and procedures of enabling the communications of a MTC service from the perspective of an application server in accordance with one of the exemplary embodiments of the present disclosure. The process flow of the MTC service request involves an AS 801, SCS1 802, SCS2 804, DNS 803, MTC-IWF1 805, and MTC-IWF2 806. The AS 801 during the process flow performs the tasks 5807 of servicing and grouping subscribers, performing group based SCS or MON selection, and performing SCS/MON-based MTC features and/or MTC functions translations & adjustment, and/or configurations translations & adjustments before sending out a MTC service request.

In the process step S808, the AS 801 sends MTC Service Request (Service group ID1, F-group_ID1, . . . ) to the SCS1. This service request contains at least two types of elements. In the first field of the MTC Service Request, the Service group ID1 is a MTC service group identifier used by the AS 801 in order to divide subscribers into groups. In the second field of the MTC Service Request, The F-group_ID1 is the feature group identifier which is an identifier of an MTC features and/or functions group used by a MON/SCS and can be obtained during the subscription process. For instance, the AS 801 could be for example an eHealthCare AS which uses Small Data

Transmission. The MTC Service Request (Service group ID1, F-group_ID1, . . . ) could then be for example SmallDataTransmission(Apple_MON_{—}1_group_{—}1, small_data_transmission_group_{—}1) where SmallDataTransmission is the name of the MTC Service Request, Apple_MON_{—}1_group_{—}1 is the group identifier used by the AS 801, and small_data_transmission_group_{—}1 would be the group identifier used by a MON obtained during the subscription process.

In response to receiving the MTC Service Request in step S808, The SCS 1 802 performs the tasks S811 of re-grouping subscribers if needed, performing MTC function translation/adjustment, and performing SCS or MON selection. In response to S808, in S809 the AS 801 sends MTC Service Request (Service group ID2, F-group_ID2, . . . ) to SCS2. In response to S809, in S810 the SCS1 802 and SCS2 804 could perform DNS queries to obtain locations of subscribers. Also in response to S809 the SCS2 804 performs the tasks 812 of re-grouping subscribers if needed, performing group-based MTC function translation/adjustment, and performing selections of SCS or MON. In response to performing S811, in S813 the SCS1 802 sends MTC Service Request (Service group ID1, F-group_ID11, . . . ) to the MTC-IWF1 805. In response to S812, in S814, the SCS2 804 sends MTC Service Request (Service group ID2, F-group_ID2, . . . ) to MTC-IWF2 806. Also in Response to S814, in S815 the SCS2 804 sends MTC Service Request (Service group ID2, F-group_ID21, . . . ) to MTC-IWF1 805. In response to S815 and Network level procedures, in S816 the SCS2 sends MTC Service Response (Service group ID2, F-group_ID2 result2, . . . ) to AS 801. In response to S813 and Network level procedures, in S817 the SCS1 sends MTC Service Response (Service group ID1, F-group_ID1 result1, . . . ) to the AS 801. It should noted that the F_group_ID in the MTC Service Request coming from the MTC-IWF represent an identifier of a MTC feature group or an identifier of a MTC feature group provided from a MON to a target SCS.

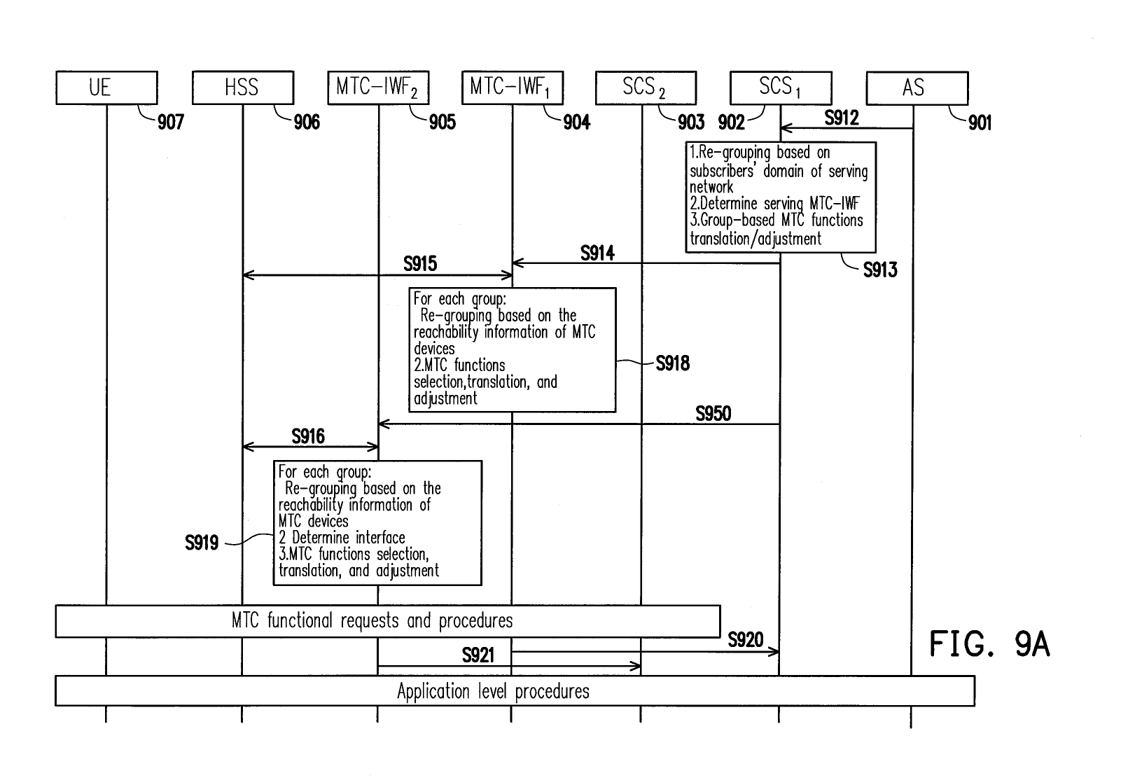

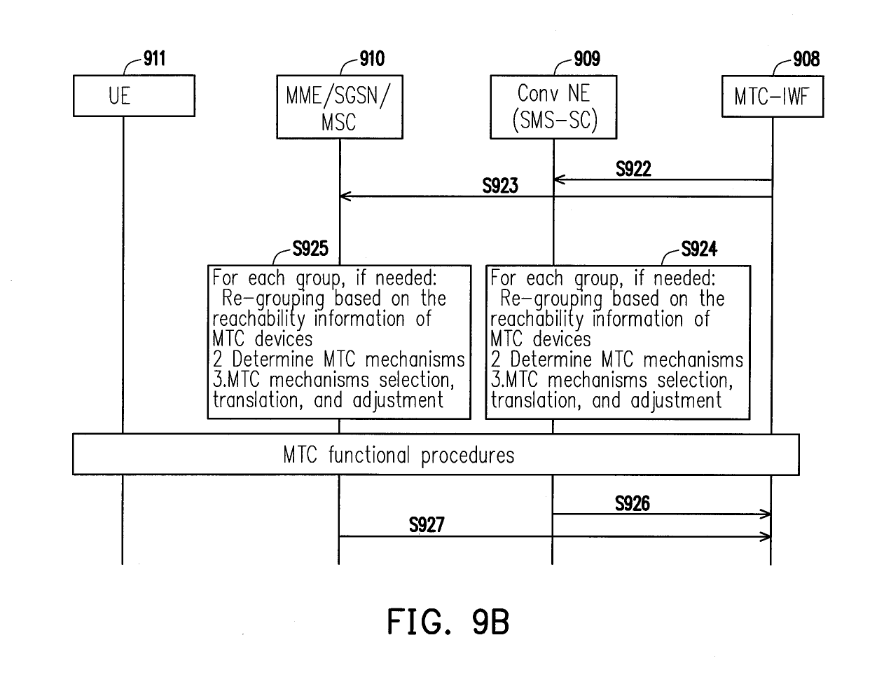

FIG. 9A illustrates a process flow procedure during a MTC service request from the perspective of a network in accordance with one of the exemplary embodiments of the present disclosure. The MTC in this example could include an AS 901, a SCS1 902, a SCS2 903, a MTC-IWF1 904, a MTC-IWF2 905, a home subscriber server (HSS) 906, and a UE 907.

In S912, the AS 901 sends MTC Service Request (Service group ID1, F-group_ID1, . . . ) to the SCS1 902. In response to S912, the SCS1 902 performs the tasks S913 of re-grouping based on subscribers' domain and/or location information, determining the serving MTC-IWF, and performing group-based MTC functions translation/adjustment.

In response to S913, in S914 the SCS1 902 sends MTC Feature Request1 (Service group ID1,Parameters11, . . . ) to the MTC-IWF1 904. In response to S914, the MTC-IWF1 904 may perform individual or group based HSS interrogate in step S915 for the current location information of UE 907 if necessary. In response to S914, the MTC-IWF1 performs the tasks 5918 of, for each group, re-grouping based on the reachability information of MTC devices and performing MTC functions selection, translation, and adjustment. In S915 and S916, the HSS 906 might perform group based HSS interrogation. In response to S913, in S950, the SCS1 sends MTC Feature Request2 (Service group ID2, Parameters21, . . . ) to the MTC-IWF2 905. In response to S950, the MTC-IWF2 905 may perform individual or group based HSS interrogate in step S916 for the current location information of UE 907 if necessary. In response to S950, the MTC-IWF2 905 performs the tasks 919 of, for each group, re-grouping based on the reachability information of MTC devices, determining the interface, and performing MTC function selection, translation, and adjustment. After 5918, in MTC functional requests and procedures and S920 the MTC-IWF1 904 sends MTC Feature Response1 (Service group ID1, Result11, . . . ) to SCS1 902. In S921, the MTC-IWF2 905 sends MTC Feature Response2 (Service group ID2, Result21, . . . ) to SCS2 903. It should be noted in FIG. 9A that SCS 901 transmits using MTC Feature Request to MTC-IWF (e.g. SCS 901 may use mtc_SmallDataTransmission( ) to request MTC-IWF to execute SmallDataTransmission( ) from eHealthCare AS). The mtc_SmallDataTransmission is a designator provided a MON/MTC-IWF for a MTC Feature Request and may include at least two types of information elements—One is MTC Service group identifier which is an identifier defined by MTC service application. The other is Parameters which is the parameter needed for a MTC Feature Request.

FIG. 9B illustrates another process flow procedure during a MTC service request from the perspective of a network in accordance with one of the exemplary embodiments of the present disclosure. The MTC procedure may include a MTC-IWF 908, a Cony NE (SMS-SC) 909, a MME/SGSN/MSC 910, and a UE 911. In S922, the MTC-IWF 908 sends MTC functional request1 (Service group ID1, parameter set1, . . . ) to the Cony NE (SMS-SC) 909. In response to S922, the Cony NE (SMS-SC) 909 if needed performs the tasks S924 of, for each group, re-grouping based on the reachability information of MTC devices, determining MTC mechanisms, and performing MTC mechanisms selection. In S923, the Cony NE (SMS-SC) 909 sends MTC Functional Request2 (Service group ID1, parameter set2, . . . ) to MME/SGSN/MSC 910. In response to S923, The MME/SGSN/MSC 910 if needed performs the tasks 5925 of, for each group re-grouping based on the reachability information of MTC devices, determining MTC mechanisms, and performing MTC mechanisms selection, translation, and adjustment. After S924, in MTC functional procedures and S926 the Cony NE (SMS-SC) 909 sends MTC Functional Response1 (Service group ID1, Results1, . . . ) to MTC-IWF 908, and after S925 in MTC functional procedures and S927, MME/SGSN/MSC 910 forwards MTC Functional Response2 (Service group ID1, Results2, . . . ) to MTC-IWF 908. It should be noted that in FIG. 9B, MTC-IWF transmits MTC Functional Request to network elements (NE) which is responsible for executing MTC functions. For instance, MTC-IWF could send toward SCS-SC “submit trigger” and request SMS-SC to send short messages to subscribers. Or the MTC-IWF could send “submit request” to MME/SGSN/MSC to request MME/SGSN/MSC to send small data using small data transmission function to subscribers. The NE which is responsible for executing MTC functions could then according to supported MTC mechanisms (e.g. broadcast, multicast, unicast, paging, and etc.) select a mechanism to execute the MTC function and may adjust related system parameters.

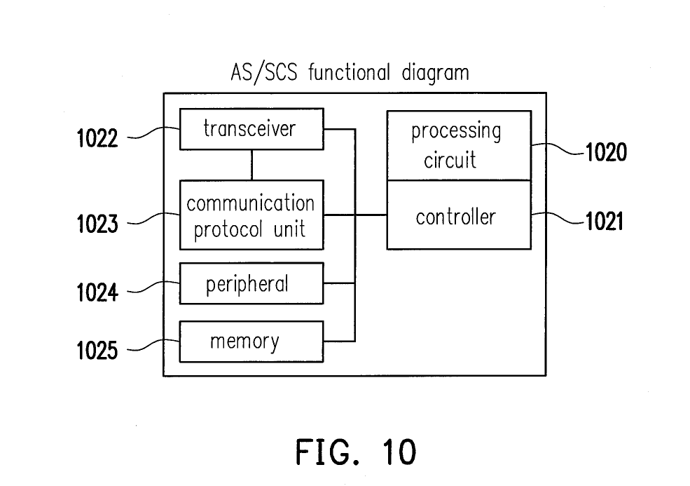

FIG. 10 illustrates device architecture of an application server (AS) or a service capability server (SCS) in accordance with one of the exemplary embodiments of the present disclosure. An AS or a SCS may include at least but not limited to the element of a transceiver 1022, a communication protocol unit 1023, a peripheral unit 1024, a memory unit 1025, a processing circuit 1020, and a controller 1021. The transceiver 1022 is connected to the communication protocol unit 1023 and provides physical layer support for transmitting wired or wireless signals following the proper communication protocol. The peripheral unit 1024 contains means such as a monitor or keyboard to communicate with the outside world. The memory 1025 includes non-volatile memory to system parameters, network data, and subscriber data and volatile memory which could serve as buffer for use by the processing circuit 1020. The controller 1021 could be a microcontroller may control and coordinate among the aforementioned device elements and may assist the processing circuit 1020 to perform processing functions.

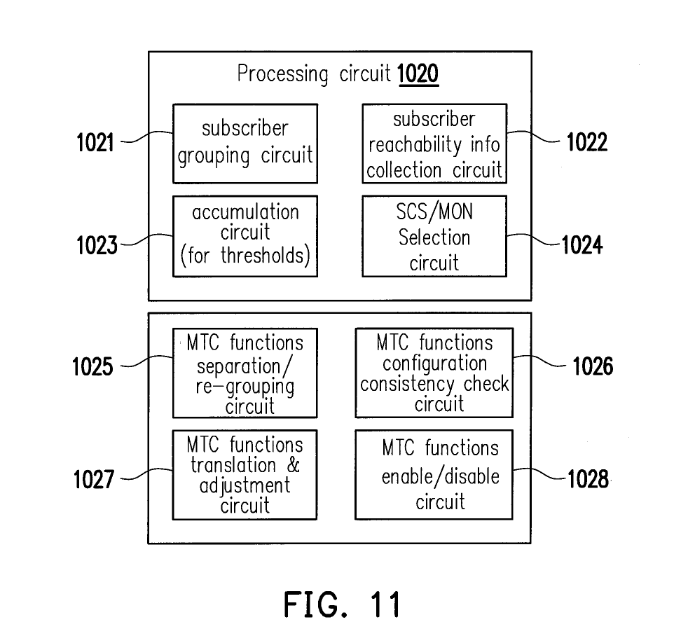

FIG. 11 illustrates the processing circuit 1020 of an application server (AS) or a service capability server (SCS) in accordance with one of the exemplary embodiments of the present disclosure. The processing circuit 1020 contains functional elements of a subscriber grouping circuit 1021, a subscriber reachability info collection circuit 1022, an accumulation circuit 1023, a SCS/MON selection circuit 1024, a MTC functions separation and re-grouping circuit 1025, a MTC functions configuration consistency check circuit 1026, a MTC functions translation and adjustment circuit 1027, and MTC function enable and disable circuit 1028. It should be noted that the functional elements of the processing circuit 1020 may be implemented with individual hardware blocks or with integrated circuits or may be implemented with software using a micro-processor, a DSP chip, a micro-controller, or a graphics programmable unit.

The subscriber grouping circuit 1021 may group subscribers according to their geographical regions or their serving MONs. The subscriber reachability info collection circuit 1022 may collect subscriber information related to their locations and their subscribed access privileges. The accumulation circuit 1023 could serve as a counter to detect whether the network thresholds are exceeded by MTC UEs. The SCS/MON Selection circuit 1024 selects the most suitable SCS/MON to deliver MTC services. The MTC function 1025 separation/re-group circuit determines whether MTC functions could be separated and separate MTC functions from a group if possible. The MTC functions configuration consistency check circuit 1026 circuit performs MTC functions configuration consistency check to ensure a MON is configured with all the required MTC functions. The MTC functions translation and adjustment circuit 1027 performs functional adjustments and translations. The MTC functions enable/disable circuit 1028 may enable or disable a certain MTC function within a function set.

In view of the aforementioned descriptions, the present disclosure is able to perform group based machine type communications (MTC) to minimize unexpected network responses by the way of group based MTC feature and/or MTC function translations and adjustments. This disclosure proposes collecting and managing MTC network level information. From the MTC network level information, grouping and re-grouping in both in the network level and the application level can be performed to minimize functional inconsistencies among required functions for a MTC service, functions supported by a network, and functions available for MTC UEs. Functional inconsistencies may be solved or alleviated by performing functional adjustment and translation. By delivering group-based MTC service requests and performing group-based MTC services, control signal overheads can be saved. By performing group based functional adjustment and translation, error signals or re-transmission request can be prevented, and thus a large quantity of MTC devices can be managed as the likelihood of network congestion or overload due to error signals could be lowered.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method of machine type communications (MTC) for use by a service provider to provide a first group based MTC service having a plurality of MTC functions to MTC subscribers, and the method comprising:
(a) grouping subscribers dynamically according to the serving network of the subscribers so that each group has one serving network;
(b) detecting for each group whether the serving network of the group supports all of the plurality of MTC functions of the MTC service;
when the serving network of the group does not support all of the plurality of the MTC functions of the first group based MTC service,
(c) adjusting the plurality of MTC functions of the first group based MTC service to produce a second group based MTC service; and
(d) delivering the second group based MTC service to the group.

2. The method of claim 1, further comprising:
when the serving network of the group supports all of the plurality of the MTC functions of the MTC service,
(e) delivering the first group based MTC service to the group.

3. The method of claim 1, wherein the step of (c) adjusting the plurality of MTC functions of the first group based MTC service to produce a second group based MTC service further comprising:
If the plurality of the MTC functions of the first group based MTC service cannot be adjusted, disable the first group based MTC service.

4. The method of claim 1, wherein when the serving network of the group is not capable of all of the plurality of the MTC functions of the MTC service, claim 1 further comprises:
determining whether another network can deliver all the plurality of MTC functions of the first group based MTC service to a subscriber in the group; and
if there is not another network which can deliver all the plurality of MTC functions of the first group based MTC service to a subscriber in the group, perform steps (c) and (d).

5. The method of claim 3, further comprising:
if there is another network which can deliver all the plurality of MTC functions of the first group based MTC service to a subscriber in the group, perform step (e) through the another network.

6. The method of claim 3, wherein step (c) adjusting the plurality of MTC functions of the first group based MTC service to produce a second group based MTC service comprises:
separating from the plurality of MTC functions of the server an incapable MTC function, wherein the incapable MTC function is not capable of being performed by the serving network;
disabling the incapable MTC function from the first group based MTC service to produce a second group based MTC service.

7. The method of claim 3, wherein step (c) adjusting the plurality of MTC functions of the first group based MTC service to produce a second group based MTC service comprises:
separating from the plurality of MTC functions of the server an incapable MTC function, wherein the incapable MTC function is not capable of being performed by the serving network; and
changing a parameter of the incapable MTC function from the first group based MTC service to produce a second group based MTC service so that the second group based MTC service has the same plurality of the MTC functions of the first MTC service but has different parameters.

8. The method of claim 3, wherein step (c) adjusting the plurality of MTC functions of the first group based MTC service to produce a second group based MTC service comprises:
separating from the plurality of MTC functions of the server an incapable MTC function, wherein the incapable MTC function is not capable of being performed by the serving network;
translating the incapable MTC function from the first group based MTC service to produce a second group based MTC service so that the second group based MTC service is the same as the first group based MTC service.

9. The method of claim 1, wherein the service provider transmits the same message to all subscribers in the same group.

10. The method of claim 1, wherein the step (d) delivering the second group based MTC service to the group comprises:
transmitting from the service provider a MTC service request comprising a service group identification, wherein the group identification is a MTC service group identifier used by the service provider to identify subscriber groups.

11. The method of claim 10, wherein the MTC service request further comprises a feature group identification, wherein the feature group identification is a MTC feature identifier used by the serving network to identify groups of MTC features.

12. The method of claim 2, wherein the step (e) delivering the first group based MTC service to the group comprises:
transmitting from the service provider a MTC service request comprising a service group identification, wherein the group identification is a MTC service group identifier used by the service provider to identify subscriber groups.

13. The method of claim 12, wherein the MTC service request further comprises a feature group identification, wherein the feature group identification is a MTC feature identifier used by the serving network to identify groups of MTC features.

14. The method of claim 1, wherein before the step of (a) grouping subscribers dynamically according to the serving network of the subscribers, the method further comprises:
the service provider gathering information related to the serving network of the subscribers from a MTC reference data.

15. The method of claim 14, wherein the MTC reference data comprises subscriber reachability information and interconnecting information among networks.

16. The method of claim 15, wherein the MTC reference data further comprises a policy for performing MTC functions translation and adjustment.

17. The method of claim 12, wherein the step (e) delivering the first group based MTC services to the group comprises:
delivering the first group based MTC services to the group through a service capability server, wherein the service capability server provides an intermediary functional support between the service provider and the network.

18. The method of claim 17, wherein when a subscriber migrates from the serving network to another serving network, the service provider locates the subscriber through the service capability server which locates the subscriber by performing a Domain Name System (DNS) query.

19. The method of claim 18, wherein when the subscriber migrates from the serving network to another serving network, the service provider detects whether the another serving network can support the first group based MTC service via an inter-connection through the service capability server.

20. The method of claim 19, further comprising:
the service provider delivers the first group based MTC service to the subscriber via the inter-connection if the another serving network can support the first group based MTC service.

21. The method of claim 19, further comprising:
adjusting the first group based MTC to produce the third group based MTC service if the another serving network cannot support the first group based MTC service; and
delivering the third group based MTC service to the subscriber via the another serving network.

22. A method of machine type communications (MTC) for use by a network to transmit a first group based MTC service having a plurality of MTC functions to MTC subscribers, and the method comprising:
grouping subscribers under the network dynamically according to reachability information of the subscribers;
detecting for each group whether the network can perform all of the plurality of MTC functions of the first group based MTC service transmitted by the network;
when the network cannot perform all of the plurality of the MTC functions of the first group based MTC service,
adjusting the plurality of MTC functions of the first group based MTC service to produce a second group based MTC service if the plurality of MTC functions of the first group based MTC service are adjustable; and
delivering the second group based MTC service to the group.

23. The method of claim 22, further comprising:
when the network can perform all of the plurality of the functions of the first group based MTC service,
delivering the first group based MTC service to the group.

24. The method of claim 23, wherein before the step of adjusting the plurality of MTC functions of the first group based MTC service to produce a second group based MTC service, claim 23 further comprises:
determining whether the plurality of MTC functions of the first group based MTC service are adjustable; and
if the plurality of MTC functions of the first group based MTC service are not adjustable,
dividing the plurality of the MTC functions of the first group based MTC service into sub-groups of MTC functions; and
re-grouping subscribers of each group according to the sub-groups of MTC functions.

25. The method of claim 23, wherein the step of delivering the first group based MTC service to the group further comprising:
determining whether a first threshold of the network has exceeded; and
delivering the first group based MTC service to the group only if the first threshold of the network has not been exceeded.

26. The method of claim 25, further comprising:
if the first threshold of the network has been exceeded, deactivating the first group based MTC service.

27. The method of claim 22, wherein after the step of adjusting the plurality of MTC functions of the first group based MTC service to produce a second group based MTC service if the plurality of MTC functions of the first group based MTC service are adjustable, the method of claim 22 further comprising:
determining whether a first threshold of the network has exceeded; and
delivering the second group based MTC service to the group if the first threshold of the network has not been exceeded.

28. The method of claim 27, further comprising:
if the first threshold of the network has been exceeded, deactivating the first group based MTC service.

29. The method of claim 25, wherein the step of adjusting the plurality of MTC functions of the first group based MTC service to produce a second group based MTC service comprises:
adjusting the plurality of MTC functions of the first group based MTC service by temporarily disabling the MTC functions which cannot be performed by subscribers of the group to produce a second group based MTC service.

30. The method of claim 25, wherein the step of adjusting the plurality of MTC functions of the first group based MTC service to produce a second group based MTC service comprises:
adjusting the plurality of MTC functions of the first group based MTC service by adjusting parameters of the MTC functions which cannot be performed by subscribers of the group to produce a second group based MTC service which contain all the plurality of MTC functions of the first group based MTC service but with different parameters.

31. The method of claim 25, wherein the step of adjusting the plurality of MTC functions of the first group based MTC service to produce a second group based MTC service comprises:
adjusting the plurality of MTC functions of the first group based MTC service by translating the MTC functions which cannot be performed by subscribers of the group to produce a second group based MTC service which contain all the plurality of MTC functions of the first group based MTC service.

32. The method of claim 22, wherein the service provider transmits the same message to all subscribers in the same group.

33. The method of claim 22, wherein the step of delivering the second group based MTC service to the group comprises:
transmitting from the service provider a MTC service request comprising a feature group identification, wherein the feature group identification is a MTC feature identifier used by the serving network to identify subscriber groups based on MTC features service group identification.

34. The method of claim 33, wherein the MTC service request further comprising a service group identification, wherein the service group identification is a MTC service group identifier used by the service provider to identify subscriber groups.

35. The method of claim 22, wherein the step of delivering the second group based MTC service to the group comprises:
transmitting from the service provider a MTC feature request comprising a MTC service group identifier and a parameter, wherein the parameter is a group based parameter for the MTC feature request.

36. The method of claim 22, wherein before the step of grouping subscribers under the network dynamically according to the reachability information of subscribers, the method further comprises:
the service provider gathering information related to the reachability information of the subscribers from a MTC reference data.

37. The method of claim 36, wherein the MTC reference data comprises subscriber reachability information, the first threshold of the network, interconnecting information among networks.

38. The method of claim 37, wherein the MTC reference data further comprises a policy for performing MTC functions translation and adjustment.

39. The method of claim 23, wherein the step of delivering the first group based MTC service to the group comprises:
transmitting the first group based MTC services to the group through a service capability server, wherein the service capability server provides an intermediary functional support between the service provider and the network.

40. A machine type communication (MTC) application server comprising a processing circuit and a transceiver connected to the processing circuit, wherein the processing circuit is configured for performing these following functions through the transceiver:
(a) grouping subscribers dynamically according to the serving network of the subscribers so that each group has one serving network;
(b) detecting for each group whether the serving network of the group supports all of the plurality of MTC functions of the MTC service;
when the serving network of the group is not capable of supporting all of the plurality of the MTC functions of the first group based MTC service,
(c) adjusting the plurality of MTC functions of the first group based MTC service to produce a second group based MTC service; and
(d) delivering the second group based MTC service to the group.

41. The application server of claim 40, wherein the processor is configured for (c) adjusting the plurality of MTC functions of the first group based MTC service to produce a second group based MTC service further comprising: when the plurality of MTC functions of the first group based MTC service cannot be adjusted, deactivating the first group based MTC service.

42. The application server of claim 40, wherein the processing circuit is further configured for:
when the serving network of the group supports all of the plurality of the MTC functions of the MTC service,
(e) delivering the first group based MTC service to the group.

43. The application server of claim 40, wherein the processing circuit is further configured for:
when the serving network of the group is not capable of all of the plurality of the MTC functions of the MTC service, determining whether another network can deliver all the plurality of MTC functions of the first group based MTC service to a subscriber in the group; and
if there is not another network which can deliver all the plurality of MTC functions of the first group based MTC service to a subscriber in the group, perform (c) and (d).

44. The application server of claim 43, wherein the processing circuit further configured for:
if there is another network which can deliver all the plurality of MTC functions of the first group based MTC service to a subscriber in the group, perform (e) through the another network.

45. The application server of claim 40, wherein the processing circuit is configured for (c) adjusting the plurality of MTC functions of the first group based MTC service to produce a second group based MTC service comprises:
separating from the plurality of MTC functions of the first group based MTC service an incapable MTC function, wherein the incapable MTC function is not capable of being performed by the serving network;
disabling the incapable MTC function from the first group based MTC service to produce a second group based MTC service.

46. The application server of claim 40, wherein the processing circuit is configured for (c) adjusting the plurality of MTC functions of the first group based MTC service to produce a second group based MTC service comprises:
separating from the plurality of MTC functions of the first group based MTC service an incapable MTC function, wherein the incapable MTC function is not capable of being performed by the serving network; and
changing a parameter of the incapable MTC function from the first group based MTC service to produce a second group based MTC service so that the second group based MTC service has the same plurality of the MTC functions of the first MTC service but has different parameters.

47. The application server of claim 40, wherein the processing circuit is configured for (c) adjusting the plurality of MTC functions of the first group based MTC service to produce a second group based MTC service comprises:
separating from the plurality of MTC functions of the server an incapable MTC function, wherein the incapable MTC function is not capable of being performed by the serving network;
translating the incapable MTC function from the first group based MTC service to produce a second group based MTC service so that the second group based MTC service is the same as the first group based MTC service.

48. The application server of claim 40, wherein the service provider transmits the same message to all subscribers in the same group.

49. The application server of claim 40, wherein the processing circuit is configured for (d) delivering the second group based MTC service to the group comprises:
transmitting from the service provider a message comprising a service group identification, wherein the group identification is a MTC service group identifier used by the service provider to identify subscriber groups.

50. The application server of claim 49, wherein the message further comprises a feature group identification, wherein the feature group identification is a MTC feature identifier used by the MTC server and the serving network to identify a group of MTC features.

51. The application server of claim 42, wherein the processing circuit is configured for (e) delivering the first group based MTC service to the group comprises:
transmitting from the service provider a message comprising a service group identification, wherein the group identification is a MTC service group identifier used by the service provider to identify subscriber groups.

52. The application server of claim 40, wherein the MTC service request further comprises a feature group identification, wherein the feature group identification is a MTC feature identifier used by the MTC server and the serving network to identify a group of MTC features.

53. The application server of claim 40, wherein before the processing circuit is configured for (a) grouping subscribers dynamically according to the serving network of the subscribers, the configuration further comprises:
gathering information related to the reachable network of the subscribers from a MTC reference data.

54. The application server of claim 53, wherein the MTC reference data comprises subscriber reachability information, interconnecting information among networks, and thresholds of the network.

55. The application server of claim 54, wherein the MTC reference data further comprises a policy for performing MTC functions translation and adjustment.

56. The application server of claim 40, wherein the processing circuit is configured for (e) delivering the first group based MTC services to the group comprises:
delivering the first group based MTC services to the group through a service capability server, wherein the service capability server provides an intermediary functional support between the service provider and the network.

57. The application server of claim 56, wherein when a subscribe migrates from the serving network to another serving network, the processing circuit is configured for locating the subscriber through the service capability server which locates the subscriber by performing a Domain Name System (DNS) query.

58. The application server of claim 57, wherein when the subscriber migrates from the serving network to another serving network, the processing circuit is configured for detecting whether the another serving network can support the first group based MTC service via an inter-connection through the service capability server.

59. The application server of claim 58, wherein the processing circuit is further configured for:
delivering the first group based MTC service to the subscriber via the inter-connection if the another serving network can support the first group based MTC service.

60. The application server of claim 58, wherein the processing circuit is further configured for:
adjusting the first group based MTC to produce the third group based MTC service if the another serving network cannot support the first group based MTC service; and
delivering the third group based MTC service to the subscriber via the another serving network.

61. A machine type communication (MTC) service capability server comprising a processing circuit and a transceiver connected to the processing circuit, wherein the processing circuit is configured for performing these following functions through the transceiver:
(a) grouping subscribers dynamically according to the reachable network of the subscribers so that each group has one serving network;
(b) detecting for each group whether the serving network of the group supports all of the plurality of MTC functions of the MTC service;
when the serving network of the group is not capable of all of the plurality of the MTC functions of the first group based MTC service,
(c) adjusting the plurality of MTC functions of the first group based MTC service to produce a second group based MTC service; and
(d) delivering the second group based MTC service to the group.

62. The service capability server of claim 61, wherein the processing circuit is further configured for:
when the serving network of the group supports all of the plurality of the MTC functions of the MTC service,
(e) delivering the first group based MTC service to the group.

63. The service capability server of claim 62, wherein the processing circuit is further configured for:
when the serving network of the group is not capable of all of the plurality of the MTC functions of the MTC service, determining whether another network can deliver all the plurality of MTC functions of the first group based MTC service to a subscriber in the group; and
if there is not another network which can deliver all the plurality of MTC functions of the first group based MTC service to a subscriber in the group, perform (c) and (d).

64. The service capability server of claim 63, wherein the processing circuit further configured for:
if there is another network which can deliver all the plurality of MTC functions of the first group based MTC service to a subscriber in the group, perform (e) through the another network.

65. The service capability server of claim 61, wherein the processing circuit is configured for (c) adjusting the plurality of MTC functions of the first group based MTC service to produce a second group based MTC service comprises:
separating from the plurality of MTC functions of the server an incapable MTC function, wherein the incapable MTC function is not capable of being performed by the serving network;
disabling the incapable MTC function from the first group based MTC service to produce a second group based MTC service.

66. The service capability server of claim 63, wherein the processing circuit is configured for (c) adjusting the plurality of MTC functions of the first group based MTC service to produce a second group based MTC service comprises:
separating from the plurality of MTC functions of the server an incapable MTC function, wherein the incapable MTC function is not capable of being performed by the serving network; and
changing a parameter of the incapable MTC function from the first group based MTC service to produce a second group based MTC service so that the second group based MTC service has the same plurality of the MTC functions of the first MTC service but has different parameters.

67. The service capability server of claim 63, wherein the processing circuit is configured for (c) adjusting the plurality of MTC functions of the first group based MTC service to produce a second group based MTC service comprises:
separating from the plurality of MTC functions of the server an incapable MTC function, wherein the incapable MTC function is not capable of being performed by the serving network;
translating the incapable MTC function from the first group based MTC service to produce a second group based MTC service so that the second group based MTC service is the same as the first group based MTC service.

68. The service capability server of claim 61, wherein the service provider transmits the same message to all subscribers in the same group.

69. The service capability server of claim 61, wherein the processing circuit is configured for (d) delivering the second group based MTC service to the group comprises:
transmitting from the service provider a MTC service request comprising a service group identification, wherein the group identification is a MTC service group identifier used by the service provider to identify subscriber groups.

70. The service capability server of claim 69, wherein the MTC service request further comprises a feature group identification, wherein the feature group identification is a MTC feature identifier used by the MTC server and the serving network to identify subscriber groups based on MTC features.

71. The service capability server of claim 62, wherein the processing circuit is configured for (e) delivering the first group based MTC service to the group comprises:
transmitting from the service provider a MTC service request comprising a service group identification, wherein the group identification is a MTC service group identifier used by the service provider to identify subscriber groups.

72. The service capability server of claim 71, wherein the MTC service request further comprises a feature group identification, wherein the feature group identification is a MTC feature identifier used by the MTC server and the serving network to identify a group of MTC features.

73. The service capability server of claim 71, wherein before the processing circuit is configured for (a) grouping subscribers dynamically according to the serving network of the subscribers, the configuration further comprises:
gathering information related to the serving network of the subscribers from a MTC reference data.

74. The service capability server of claim 73, wherein the MTC reference data comprises subscriber reachability information and interconnecting information among networks.

75. The service capability server of claim 74, wherein the MTC reference data further comprises a policy for performing MTC functions translation and adjustment.

76. The service capability server of claim 71, wherein the processing circuit is configured for (e) delivering the first group based MTC services to the group comprises:
delivering the first group based MTC services to the group from an application server by providing an intermediary functional support between the application server and the network.

77. The service capability server of claim 76, wherein when a subscriber migrates from the serving network to another serving network, the processing circuit is configured for locating the subscriber by performing a Domain Name System (DNS) query.

78. The service capability server of claim 77, wherein when the subscriber migrates from the serving network to another serving network, the processing circuit is configured for detecting whether the another serving network can support the first group based MTC service via an inter-connection through another service capability server.

79. The service capability server of claim 78, wherein the processing circuit is further configured for:
delivering the first group based MTC service to the subscriber via the inter-connection with the another service capability server if the another serving network can support the first group based MTC service.

80. The service capability server of claim 78, wherein the processing circuit is further configured for:
adjusting the first group based MTC to produce the third group based MTC service if the another serving network cannot support the first group based MTC service; and
delivering the third group based MTC service to the subscriber via the another serving network.

81. A network for machine type communication (MTC) configured for:
grouping subscribers under the network dynamically according to reachability information of the subscribers;
detecting for each group whether the group can perform all of the plurality of MTC functions of the first group based MTC service transmitted by the network;
when the group cannot perform all of the plurality of the MTC functions of the first group based MTC service,
adjusting the plurality of MTC functions of the first group based MTC service to produce a second group based MTC service if the plurality of MTC functions of the first group based MTC service are adjustable; and
delivering the second group based MTC service to the group.

82. The network of claim 81, further configured for:
when the group can perform all of the plurality of the functions of the first group based MTC service,
delivering the first group based MTC service to the group.

83. The network of claim 81, wherein before the adjusting the plurality of MTC functions of the first group based MTC service to produce a second group based MTC service, claim 81 is further configured for:
determining whether the plurality of MTC functions of the first group based MTC service are adjustable; and
if the plurality of MTC functions of the first group based MTC service are not adjustable,
dividing the plurality of the MTC functions of the first group based MTC service into sub-groups of MTC functions; and
re-grouping subscribers of each group according to the sub-groups of MTC functions.

84. The network of claim 82, wherein the delivering the first group based MTC service to the group is further configured for:
determining whether a first threshold of the network has exceeded; and
delivering the first group based MTC service to the group only if the first threshold of the network has not been exceeded.

85. The method of claim 84, further comprising:
if the first threshold of the network has been exceeded, disable the first group based MTC service.

86. The network of claim 79, wherein after the adjusting the plurality of MTC functions of the first group based MTC service to produce a second group based MTC service if the plurality of MTC functions of the first group based MTC service are adjustable, the network of claim 79 is further configured for:
determining whether a first threshold of the network has exceeded; and
delivering the second group based MTC service to the group if the first threshold of the network has not been exceeded.

87. The method of claim 86, further comprising:
if the first threshold of the network has been exceeded, disable the first group based MTC service.

88. The network of claim 84, wherein the adjusting the plurality of MTC functions of the first group based MTC service to produce a second group based MTC service comprising:
adjusting the plurality of MTC functions of the first group based MTC service by disabling the MTC functions which cannot be performed by subscribers of the group to produce a second group based MTC service.

89. The network of claim 84, wherein the adjusting the plurality of MTC functions of the first group based MTC service to produce a second group based MTC service comprises:
adjusting the plurality of MTC functions of the first group based MTC service by adjusting parameters of the MTC functions which cannot be performed by subscribers of the group to produce a second group based MTC service which contain all the plurality of MTC functions of the first group based MTC service but with different parameters.

90. The network of claim 84, wherein the adjusting the plurality of MTC functions of the first group based MTC service to produce a second group based MTC service comprises:
adjusting the plurality of MTC functions of the first group based MTC service by translating the MTC functions which cannot be performed by subscribers of the group to produce a second group based MTC service which contain all the plurality of MTC functions of the first group based MTC service.

91. The network of claim 81, wherein the service provider transmits the same message to all subscribers in the same group.

92. The network of claim 81, wherein the delivering the second group based MTC service to the group comprises:
transmitting from the service provider a MTC service request comprising a feature group identification, wherein the feature group identification is a MTC feature identifier used by the serving network to identify a group of MTC features service group identification.

93. The network of claim 92, wherein the MTC service request further comprising a service group identification, wherein the service group identification is a MTC service group identifier used by the service provider to identify subscriber groups.

94. The network of claim 81, wherein the delivering the second group based MTC service to the group comprises:
transmitting from the service provider a MTC feature request comprising a MTC service group identifier and a parameter, wherein the parameter is a group based parameter for the MTC feature request.

95. The network of claim 81, wherein before the grouping subscribers under the network dynamically according to the reachability information of the subscribers, the network is further configured for:
the service provider gathering information related to the reachability information of the subscribers from a MTC reference data.

96. The network of claim 95, wherein the MTC reference data comprises subscriber reachability information, the first threshold of the network, and interconnecting information among networks.

97. The network of claim 96, wherein the MTC reference data further comprises a policy for performing MTC functions translation and adjustment.

98. The network of claim 81, wherein the delivering the first group based MTC service to the group comprises:
transmitting the first group based MTC services to the group through a service capability server, wherein the service capability server provides an intermediary functional support between the service provider and the network.
